(19) United States
(12) Patent Application Publication
(10) Pub. No.: US 2017/0269499 A1
(43) Pub. Date: Sep. 21, 2017

(54) Image Forming Method and Image Forming Apparatus

(71) Applicant: FUJI XEROX CO., LTD., Tokyo (JP)

(72) Inventors: Yuka ISHIHARA, Kanagawa (JP); Satomi HARA, Kanagawa (JP); Masaru TAKAHASHI, Kanagawa (JP); Masahiro TAKAYAMA, Kanagawa (JP)

(73) Assignee: FUJI XEROX CO., LTD., Tokyo (JP)

(21) Appl. No.: 15/240,545

(22) Filed: Aug. 18, 2016

(30) Foreign Application Priority Data
Mar. 16, 2016 (JP) 2016-052922

(51) Int. Cl. G03G 9/00

(52) U.S. Cl. CPC G03G 15/0266

(57) ABSTRACT

An image forming method includes developing an electrostatic charge image on the surface of an image holding member by a developer including toner particles which contain a binder resin, a flake shape brilliant pigment, and a layered inorganic material, transferring the developed toner image onto a surface of a recording medium, and fixing the toner image, which is a brilliant image, by passing the recording medium through a contact region between a fixing member and a pressing member pressed to the fixing member, the brilliant image satisfying (1) at a depth of 200 nm, A<10, 10≦B≦50, and 20≦C≦70 and (2) at a depth of 1,000 nm, 10≦A≦40, 20≦B≦60, and 20≦C≦50, wherein A, B and C are element amounts (atomic %) of aluminium, silicon, and carbon, respectively.

### CROSS-REFERENCE TO RELATED APPLICATIONS

This application is based on and claims priority under 35 USC 119 from Japanese Patent Application No. 2016-052922 filed Mar. 16, 2016.

### BACKGROUND

### Technical Field

The present invention relates to an image forming method and an image forming apparatus.

### SUMMARY

According to an aspect of the invention, there is provided an image forming method including:

charging a surface of an image holding member;

forming an electrostatic charge image on a charged surface of the image holding member;

developing the electrostatic charge image formed on the surface of the image holding member as a developed image by using an electrostatic charge image developer including toner particles which contain a binder resin, a flake shape brilliant pigment, and a layered inorganic material;

transferring the toner image formed on the surface of the image holding member onto a surface of a recording medium; and

fixing the toner image, which is a brilliant image, on the surface of the recording medium by passing the recording medium onto which the toner image is transferred through a contact region between a fixing member and a pressing member is pressed to the fixing member,

wherein the brilliant image satisfies conditions (1) and (2) below:

(1) at a depth of 200 nm of the brilliant image, A<10, 10≦B≦50, and 20≦C≦70 and

(2) at a depth of 1,000 nm of the brilliant image, 10≦A≦40, 20≦B≦60, and 20≦C≦50,

wherein A, B and C are element amounts (atomic %) analyzed by X-ray photoelectron spectroscopy, A is an aluminium element amount, B is a silicon element amount, and C is a carbon element amount.

### BRIEF DESCRIPTION OF THE DRAWINGS

Exemplary embodiments of the present invention will be described in detail based on the following figures, wherein:

FIG. 1 is a cross-sectional diagram schematically showing an example of toner particles used in an image forming method according to the exemplary embodiment;

FIG. 2 is a schematic configuration diagram showing an example of an image forming apparatus according to the exemplary embodiment;

FIG. 3 is a side cross-sectional diagram showing an example of a fixing device provided in the image forming apparatus according to the exemplary embodiment; and

FIG. 4 is a side cross-sectional diagram showing an example of a fixing device provided in the image forming apparatus according to the exemplary embodiment.

### DETAILED DESCRIPTION

Description will be given below of the embodiment of the invention. The description and examples are for illustrating an embodiment and are not intended to limit the range of the invention.

In the present specification, the “electrostatic charge image developing toner” is also simply referred to as “toner” and the “electrostatic charge image developer” is also simply referred to as “developer”.

The image forming method according to the exemplary embodiment includes charging a surface of an image holding member; electrostatic charge image forming an electrostatic charge image on the surface of the charged image holding member; developing the electrostatic charge image formed on the surface of the image holding member as a toner image by using an electrostatic charge image developer including toner particles which contain a binder resin, a flake shape brilliant pigment, and a layered inorganic material; transferring the toner image formed on the surface of the image holding member onto a surface of a recording medium; and passing the recording medium onto which the toner image is transferred is passed through a contact region between a fixing member and a pressing member which is pressed to the fixing member to thereby fix the toner image, which is a brilliant image, on the surface of the recording medium, in which the brilliant image satisfies conditions (1) and (2).

The image forming apparatus according to the exemplary embodiment includes an image holding member; a charging unit which charges a surface of the image holding member; an electrostatic charge image forming unit which forms an electrostatic charge image on the surface of the charged image holding member; a developing unit which stores an electrostatic charge image developer including toner particles which contain a binder resin, a flake shape brilliant pigment, and a layered inorganic material and which develops the electrostatic charge image formed on the surface of the image holding member as a toner image using an electrostatic charge image developer; a transfer unit which transfers the toner image formed on the surface of the image holding member onto a surface of a recording medium; and a fixing unit which has a fixing member and a pressing member is pressed to the fixing member, and passes the recording medium onto which the toner image is transferred through a contact region between the fixing member and the pressing member to thereby fix the brilliant image on the surface of the recording medium, wherein the brilliant image satisfies conditions (1) and (2) below.

Condition (1): at a depth of 200 nm of the brilliant image, A<10, 10≦B≦50, and 20≦C≦70

Condition (2): at a depth of 1,000 nm of the brilliant image, 10≦A≦40, 20≦B≦60, and 20≦C≦50

In condition (1) and condition (2) described above, A, B and C are element amounts (atomic %) analyzed by X-ray photoelectron spectroscopy, A is an aluminum element amount, B is a silicon element amount, and C is a carbon element amount.

In condition (1), A is preferably A<5, B is preferably 10≦B≦40, and C is preferably 20≦C≦60. In condition (2), A is preferably 20≦A≦40, B is preferably 20≦B≦50, and C is preferably 20≦C≦40.

In condition (1), each of the elements amounts (atomic %) of the aluminum, silicon, and carbon is shown with respect to the total element amount at a depth of 200 nm of the brilliant image. In condition (2), each of the elements amounts (atomic %) of the aluminum, silicon, and carbon is shown with respect to the total element amount at a depth of 1,000 nm of the brilliant image. The element distribution of condition (1) and condition (2) is analyzed by depth direction analysis using X-ray photoelectron spectroscopy.

In the image forming method and an image forming apparatus according to the exemplary embodiment, when using the electrostatic charge image developer including toner particles containing a binder resin, a flake shape brilliant pigment, and a layered inorganic material, it is estimated that the aluminum element detected in the brilliant image is mainly derived from the brilliant pigment (in particular, an aluminum pigment), the silicon element is mainly derived from the layered inorganic material, and the carbon element is mainly derived from the binder resin.

Without being limited to an image formed using only toner particles containing a binder resin, a flake shape brilliant pigment, and a layered inorganic material (also referred to below as “brilliant toner particles”), the brilliant image in the exemplary embodiment may be an image which is a toner layer (also referred to below as “brilliant toner layer”) in which at least the surface toner layer is formed using only brilliant toner particles, and, for example, images where a brilliant toner layer is laminated on a toner layer formed using at least one type of toner particles selected from yellow, magenta, cyan, and black are also included. The brilliant image in the exemplary embodiment is an image which has a brilliant toner layer on at least the surface, for which the area and thickness are determined by X-ray photoelectron spectroscopy in an analysis apparatus. One embodiment of the brilliant image in the exemplary embodiment is a solid image formed using only brilliant toner particles.

In the related art, in an image forming method in which a recording medium onto which a toner image including a flake shape brilliant pigment is transferred is passed through a contact region (also referred to below as “fixing nip”) between a fixing member and a pressing member pressed to the fixing member to fix a brilliant image on the recording medium surface, the image gloss is decreased as the brilliant image forming is repeated. It is estimated that this phenomenon occurs because the edge portion of the flake shape brilliant pigment is exposed on the surface of the brilliant image when the fixing member fixes a toner image on a recording medium, thus the edge portion cracks the fixing member surface, and the cracks on the fixing member surface are increased or deepened as the brilliant image forming is repeated.

In contrast, according to the image forming method and the image forming apparatus according to the exemplary embodiment, the image gloss is not easily decreased even when brilliant images are repeatedly formed. In the image forming method and the image forming apparatus according to the exemplary embodiment, it is estimated that, by satisfying condition (1) and condition (2), cracks of the fixing member due to the flake shape brilliant pigment are prevented. As the mechanism, the following may be considered.

The element distribution of condition (1) reflects that, at a depth of 200 nm in the brilliant image, the brilliant pigment is reduced, and the layered inorganic material is increased in comparison with the brilliant pigment, and that an amount determined to be sufficient of the binder resin is also present.

The element distribution of requirements (2) reflects that in a region at a depth of 1,000 nm of the brilliant image, there is the brilliant pigment layer (a layer in which the flake shape brilliant pigment is disposed to face the recording medium surface while in a state of being parallel or close to parallel thereto), the layered inorganic material is present at the periphery of the brilliant pigment layer, and the binder resin is also present in an amount determined to be sufficient at the periphery of the brilliant pigment layer.

That is, condition (1) and condition (2) have the meaning that the brilliant pigment layer is in a region at a depth of 1,000 nm, and that a region at a depth of 200 nm, which is a region closer to the brilliant image surface than the brilliant pigment layer, is covered with the layered inorganic material and the binder resin.

Such brilliant images are images formed by preventing exposure of the edge portion of the brilliant pigment during the image fixing and, additionally, are images where the brilliant pigment is disposed to be present at a depth at which it is possible to impart brilliance to the image. Accordingly, in the image forming method and the image forming apparatus according to the exemplary embodiment, since the brilliance is expressed in the image and cracks of the fixing member due to the brilliant pigment are prevented, the image gloss is not easily decreased even when repeatedly forming brilliant images.

Condition (1) and condition (2) are controlled, for example, as follows.
When granulating the toner particles, a cross-linked structure is formed in the binder resin, the brilliant pigment is encapsulated in the toner particles such that the brilliant pigment is coated with the cross-linked binder resin, and the layered inorganic material is distributed unevenly in a region close to the surface of the brilliant toner particles.
The toner particles are formed of a core (core particle) and a coating layer (shell layer) which coats the core, a brilliant pigment is contained in the core, and the layered inorganic material is contained in the coating layer.

It is also possible to control condition (1) and condition (2) according to the fixing conditions during image fixing. Detailed description will be given below.

Description will be given below of the material, manufacturing method, and physical properties of the developer (the developer which the image forming apparatus according to the exemplary embodiment stores in the developing unit) used in the image forming method according to the exemplary embodiment.

### Electrostatic Charge Image Developer

The developer in the exemplary embodiment includes at least toner particles. An external additive may be attached to the surface of the toner particles. In the present disclosure, toner to which an external additive is attached to the toner particle surface may be referred to as an “external additive toner”.

The developer in the exemplary embodiment may be a single-component developer including only toner particles or an external additive toner, or may be a two-component developer in which toner particles or an external additive toner are mixed with a carrier.

### Toner Particles

The brilliant toner particles in the exemplary embodiment include a binder resin, a flake shape brilliant pigment, and a layered inorganic material. The brilliant toner particles may further include a release agent, a coloring agent other than a brilliant pigment, and the like.

The brilliant toner particles may be toner particles with a single layer structure, or may be toner particles with a so-called core and shell structure formed of a core (core particles) and a coating layer (shell layer) which coats the core. The brilliant toner particles with a core and shell structure, for example, have a core including the binder resin and the brilliant pigment and a coating layer including the binder resin and the layered inorganic material.

### Binder Resin

Examples of binder resins include homopolymers of monomers such as styrenes (for example, styrene, para-chloro styrene, α-methyl styrene, or the like), (meth) acrylic acid esters (for example, methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, 2-ethylhexyl methacrylate, or the like), ethylenically unsaturated nitriles (for example, acrylonitrile, methacrylonitrile, or the like), vinyl ethers (for example, vinyl methyl ether, vinyl isobutyl ether, or the like), vinyl ketones (vinyl methyl ketone, vinyl ethyl ketone, vinyl isopropenyl ketone, or the like), olefins (for example, ethylene, propylene, butadiene, or the like) or vinyl resins formed of copolymers combining two or more types of these monomers.

Examples of binder resins include non-vinyl resins such as epoxy resin, polyester resin, polyurethane resin, polyamide resin, cellulose resin, polyether resin, or modified rosin, mixtures of the above and the vinyl resin, graft polymers, and the like obtained by polymerizing vinyl monomers in the presence of the above.

These binder resins may be used alone or may be used in a combination of two or more types thereof.

Polyester resins are suitable as the binder resin. Examples of polyester resins include polycondensates of a polyvalent carboxylic acid and polyol.

Examples of polyvalent carboxylic acid include aliphatic dicarboxylic acid (for example, oxalic acid, malonic acid, maleic acid, fumaric acid, citraconic acid, itaconic acid, glutaconic acid, succinic acid, alkenylsuccinic acid, adipic acid, sebacic acid, or the like), alicyclic dicarboxylic acids (for example, cyclohexane dicarboxylic acid, or the like), aromatic dicarboxylic acid (for example, terephthalic acid, isophthalic acid, phthalic acid, naphthalene dicarboxylic acid, or the like), anhydrides thereof, or lower alkyl esters thereof (for example, with 1 to 5 carbon atoms). Among the above, an aromatic dicarboxylic acid is preferable as the polyvalent carboxylic acid.

As the polyvalent carboxylic acid, dicarboxylic acid may be used together with a trivalent or higher carboxylic acid having a cross-linked structure or branched structure. Examples of trivalent or higher carboxylic acids include trimellitic acid, pyromellitic acid, anhydrides thereof, lower alkyl esters thereof (for example, with 1 to 5 carbon atoms), and the like.

The polyvalent carboxylic acids may be used as one type alone, or may be used in a combination of two or more types thereof.

Examples of polyols include aliphatic diols (for example, ethylene glycol, diethylene glycol, triethylene glycol, propylene glycol, butane diol, hexane diol, neopentyl glycol, and the like), alicyclic diols (for example, cyclohexane diol, cyclohexane dimethanol, hydrogenated bisphenol A, or the like), aromatic diols (for example, ethylene oxide adducts of bisphenol A, propylene oxide adducts of bisphenol A, and the like). Among the above, preferable examples of polyols include aromatic diols, and alicyclic dials, and aromatic dials are more preferable.

As the polyols, diols may be used together with a trivalent or higher carboxylic acid having a cross-linked structure or branched structure. Examples of trivalent or higher polyols include glycerin, trimethylol propane, and pentaerythritol.

Polyols may be used as one type alone, or may be used in a combination of two or more types thereof.

Glass transition temperature (Tg) of the polyester resin is preferably 50° C. to 80° C., and more preferably 50° C. to 65° C.

The glass transition temperature is determined using a DSC curve obtained by differential scanning calorimetry (DSC), more specifically, determined using the “extrapolated glass transition initiation temperature” described in the method for determining the glass transition temperature of the “transition temperature measurement method for plastics” in JIS K7121-1987.

The weight average molecular weight (Mw) of the polyester resin is preferably 5,000 to 1,000,000, and more preferably 7,000 to 500,000. The number average molecular weight (Mn) of the polyester resin is preferably 2,000 to 100,000. The molecular weight distribution (Mw/Mn) of the polyester resin is preferably 1.5 to 100, and more preferably 2 to 60.

The weight average molecular weight and number average molecular weight are measured by gel permeation chromatography (GPC). The molecular weight measurement by GPC is performed in a THF solvent using a column, TSKgel SuperHM-M (15 cm) manufactured by Tosoh using GPC HLC-8120GPC manufactured by Tosoh as a measuring apparatus. The weight average molecular weight and number average molecular weight are calculated using a molecular weight calibration curve created from the measurement results using a monodisperse polystyrene standard sample.

The polyester resin is obtained by a known preparation method. Specifically, for example, the polyester resin is obtained by a method in which the polymerization temperature is set to 180° C. to 230° C., the pressure in the reaction system is reduced as necessary, and reaction is carried out while removing water or alcohol generated during condensation.

In a case where the monomers of the raw materials are not dissolved or compatible under the reaction temperature, a high boiling point solvent may be added as a solubilizing agent to carry out the dissolution. In such a case, the polycondensation reaction is carried out while distilling off the solubilizing agent. In a case where a monomer with poor compatibility is present in the polymerization reaction, polycondensation with the main component may be carried out after carrying out polycondensation between the monomer with poor compatibility and an acid or alcohol to be polycondensed in advance.

Examples of polyester resins also include modified polyester resins in addition to the non-modified polyester resin described above. The modified polyester resin is a polyester resin in which a linking group other than the ester bond is present and a polyester resin in which a resin different to the polyester resin is bound with a covalent bond, an ionic bond, or the like. Examples of modified polyester resins include polyester resins with terminals modified where a functional group such as an isocyanate group which reacts with acid groups or hydroxyl groups is introduced, and polyester resins where a terminal is modified by reaction with an active hydrogen compound.

Particularly preferable examples of modified polyester resin include urea-modified polyester resins. When the brilliant toner particles include a urea-modified polyester resin as the binder resin, the cracks of the fixing member due to the brilliant pigment are further prevented. The mechanism thereof is considered to be that the resin coating property of the brilliant pigment is improved by the urea-modified polyester resin. The content of the urea-modified polyester resin is preferably from 5% by weight to 40% by weight, and more preferably from 10% by weight to 20% by weight with respect to the total amount of the binder resin.

The urea-modified polyester resin may be a urea-modified polyester resin obtained by a reaction (at least one of a cross-linking reaction and elongation reaction) between a polyester resin having an isocyanate group (referred to below as “polyester prepolymer”) and an amine compound. A urethane bond may be present in the urea-modified polyester in addition to the urea bond.

Examples of polyester prepolymers include polyester having a group having active hydrogen and a polyvalent isocyanate compound. Examples of the group having active hydrogen include hydroxyl groups (alcoholic hydroxyl groups and phenolic hydroxyl groups), amino groups, carboxyl groups, mercapto groups, and the like, and alcoholic hydroxyl groups are preferable. Examples of polyvalent isocyanate compounds include aliphatic polyisocyanates (tetramethylene diisocyanate, hexamethylene diisocyanate, 2,6-diisocyanate methyl caproate, or the like); alicyclic polyisocyanates (isophorone diisocyanate, cyclohexyl methane diisocyanate, or the like); aromatic diisocyanates (tolylene diisocyanate, diphenylmethane diisocyanate, or the like), aromatic aliphatic diisocyanates (α, α, α′, α′-tetramethyl xylylene diisocyanate, or the like); isocyanurates; compounds in which polyisocyanate is blocked with a blocking agent such as a phenol derivative, oxime, and caprolactam. The polyvalent isocyanate may be used as one type alone, or may be used in a combination of two or more types thereof.

The content of the site derived from the polyvalent isocyanate compound in the polyester prepolymer is preferably 0.5% by weight to 40% by weight with respect to the entire polyester prepolymer, more preferably 1% by weight to 30% by weight, and even more preferably 2% by weight to 20% by weight. The average number of isocyanate groups per one molecule of polyester prepolymer is preferably 1 or more, more preferably 1.5 to 3, and even more preferably 1.8 to 2.5.

Examples of the amine compound to be reacted with the polyester prepolymer include diamine, trivalent or higher polyamine, amino alcohol, amino mercaptan, amino acid, compounds in which the amino group of the amine compound is blocked, and the like.

Examples of diamines include aromatic diamines (phenylenediamine, diethyl toluene diamine, 4,4′diaminodiphenylmethane, or the like); alicyclic diamines (4, 4′-diamino-3,3′-dimethyl dicyclohexyl methane, diamine cyclohexane, isophoronediamine, or the like); aliphatic diamines (ethylene diamine, tetramethylene diamine, hexamethylene diamine, and the like), and the like. Examples of trivalent or higher polyamines include diethylenetriamine, triethylenetetramine, and the like. Examples of amino alcohols include ethanolamine, hydroxyethyl aniline, and the like. Examples of amino mercaptans include amino ethyl mercaptan, amino propyl mercaptan, and the like. Examples of amino acids include amino propionic acid, aminocaproic acid, and the like.

Examples of the above-described compounds in which the amino group of the amine compound is blocked include ketimine compounds, oxazoline compounds, and the like derived from the amine compounds and ketone compounds described above (acetone, methyl ethyl ketone, methyl isobutyl ketone, or the like).

As the amine compound, ketimine compounds are preferable. The amine compounds may be used as one type alone, or may be used in a combination of two or more types thereof.

The urea-modified polyester resin may be a resin in which the molecular weight is adjusted after reaction by adjusting the reaction between the polyester prepolymer and the amine compound using a stopping agent (referred to below as the “cross-linking/elongation stopping agent) for stopping at least one reaction of the cross-linking reaction and the elongation reaction. Examples of cross-linking/elongation stopping agents include monoamine (diethylamine, dibutylamine, butylamine, lauryl amine, or the like), compounds (ketimine compounds) obtained by blocking the amino groups of the monoamine, and the like.

The glass transition temperature of the urea-modified polyester resin is preferably from 40° C. to 65° C., and more preferably from 45° C. to 60° C. The weight average molecular weight of the urea-modified polyester resin is preferably from 10,000 to 500,000, and more preferably from 30,000 to 100,000. The number average molecular weight of the urea-modified polyester resin is preferably from 2,500 to 50,000, and more preferably from 2,500 to 30,000.

As the binder resin, a polyester resin having a cross-linked structure is preferable. Examples of polyester resins having a cross-linked structure include polyester resins including a trivalent carboxylic acid in a polymerization component, urea-modified polyester resins, and the like.

The content of the binder resin is preferably 40% by weight to 95% by weight with respect to the total amount of the toner particles, more preferably 50% by weight to 90% by weight, and even more preferably 60% by weight to 85% by weight.

### Brilliant Pigment

The brilliant pigment is a pigment which exhibits brilliance. Examples of brilliant pigments include powder of metals such as aluminum, brass, bronze, nickel, stainless steel, and zinc; mica coated with titanium oxide, yellow iron oxide, or the like; flaky crystals or plate-shaped crystals such as aluminosilicate, basic carbonate, barium sulfate, titanium oxide, and bismuth oxychloride; flaky glass powder, metal deposited flaky glass powder; guanine crystals; and the like.

As the brilliant pigment, metal powder is preferable from the point of view of the specular reflection intensity, flake shape metal powder is more preferable from the point of view of a higher specular reflection intensity, and aluminum is preferable from the point of view of easily obtaining a flake shape powder. That is, as the brilliant pigment, a flake shape aluminum powder is preferable. The surface of the metal powder may be coated with an acrylic resin, a polyester resin, or the like.

The shape of the brilliant pigment is flake shape (flaky). The ratio of the average length in the long axis direction and the average length in the thickness direction of the brilliant pigment (average length of the long axis direction/average length of the thickness direction) is preferably from 5 to 200, more preferably from 10 to 100, and even more preferably from 30 to 70. The average length of the long axis direction of the brilliant pigment is preferably from 1 μm to 20 μm, and more preferably from 3 μm to 10 μm from the point of view of preventing a decrease in brilliance.

The content of the brilliant pigment is, for example, from 1% by weight to 50% by weight, preferably from 5% by weight to 50% by weight, and more preferably from 10% by weight to 30% by weight with respect to the total amount of the toner particles.

### Layered Inorganic Material

Examples of layered inorganic materials include clay minerals, and the like. Examples of clay minerals include montmorillonite, smectite, hydrotalcite, beidellite, nontronite, hectorite, saponite, sauconite, stevensite, bentonite, mica minerals, trioctahedral vermiculite, paragonite, clintonite, anandite, and the like. The layered inorganic material may be subjected to an organic process by intercalation.

The layered inorganic material included in the brilliant toner particles are preferably montmorillonite from the point of view of further preventing cracks of the fixing member due to the brilliant pigment.

The shape of the layered inorganic material preferably has a flake shape shape (flaky). The ratio of the average length of the long axis direction/the average length of the thickness direction of the layered inorganic material (average length of the long axis direction/average length of the thickness direction) is preferably 5 to 100, more preferably 10 to 70, and even more preferably 30 to 60 from the point of view of further preventing cracks of the fixing member due to the brilliant pigment. The average length of the long axis direction of the layered inorganic material is preferably 0.1 μm to 3 μm, more preferably 0.5 μm to 2.5 μm, and even more preferably 1.0 μm to 2.0 μm from the point of view of further preventing cracks of the fixing member due to the brilliant pigment.

The content of the layered inorganic material is preferably 0.005% by weight or more with respect to the total amount of the toner particles, more preferably 0.01% by weight or more, and even more preferably 0.1% by weight or more from the point of view of further preventing cracks of the fixing member due to the brilliant pigment, and preferably 2% by weight or less, more preferably 1% by weight or less, and even more preferably 0.5% by weight or less from the point of view of excellent brilliance in the brilliant toner particles.

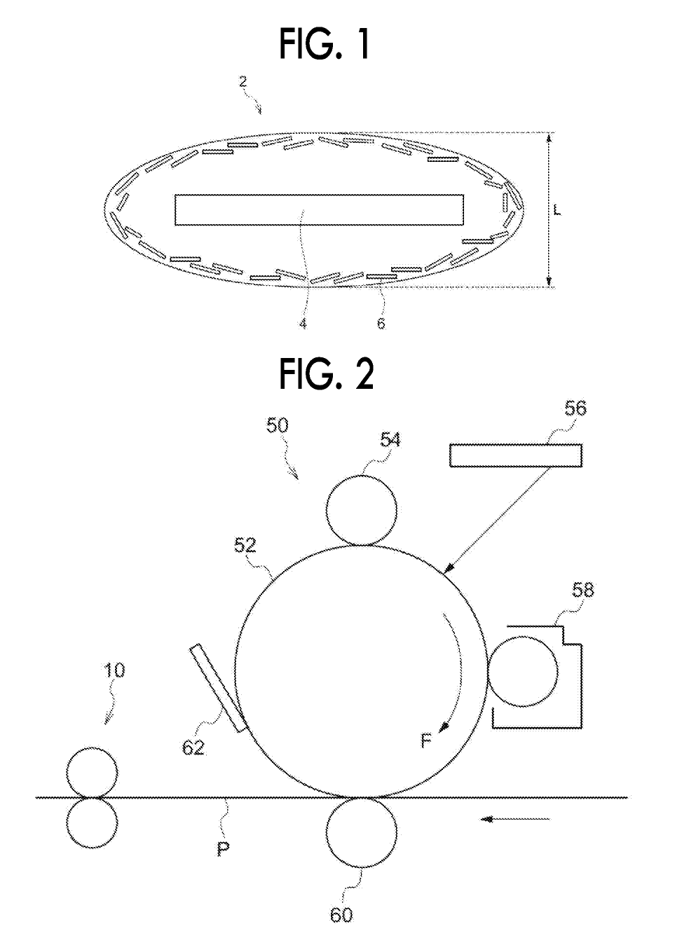

The layered inorganic material is preferably unevenly distributed in the region close to the surface of the brilliant toner particles. FIG. 1 is a schematic diagram of a cross-section of brilliant toner particles and L shows the thickness of the brilliant toner particles. Brilliant toner particles 2 shown in FIG. 1 contain a brilliant pigment 4 and a layered inorganic material 6 and the layered inorganic material 6 is unevenly distributed in a region close to the surface of the brilliant toner particles 2. Below, that the layered inorganic material is unevenly distributed in a region close to the surface of the toner particles refers to “uneven distribution of the layered inorganic material in the toner particle surface layer”. It is possible for the degree of the uneven distribution of the layered inorganic material in the toner particle surface layer to be shown by the following element analysis.

By depth direction analysis using X-ray photoelectron spectroscopy, element analysis is performed in a range of a depth of 5 nm to 20 nm from the toner particle surface. In particular, the presence of two or more types of elements among Si, Al, and Mg is identified and {(Si element content+Al element amount+Mg element content)÷carbon element amount×100} is calculated and set as the degree of uneven distribution of the layered inorganic material in the toner particle surface layer. Below, the numerical value obtained from the analysis described above and the calculation formula is referred to as “the index of uneven distribution of the layered inorganic material in the toner particle surface layer”. the index of uneven distribution of the layered inorganic material in the toner particle surface layer is preferably 80 or more, more preferably 85 or more, and even more preferably 90 or more from the point of view of further preventing cracks of the fixing member due to the brilliant pigment.

Regarding the layered inorganic material, 80% or more of all of the layered inorganic material is preferably present in a range of a depth of 5 nm to 20 nm from the toner particle surface. Below, the ratio of the layered inorganic material present in a range of a depth of 5 nm to 20 nm from the toner particle surface is referred to as the “surface layer presence ratio of the layered inorganic material”. The surface layer presence ratio of the layered inorganic material is preferably 80% or more, more preferably 85% or more, and more preferably 90% or more from the point of view of further preventing cracks of the fixing member due to the brilliant pigment. The surface layer presence ratio of the layered inorganic material is determined by the following method.

The epoxy resin is solidified by mixing the toner particles in the epoxy resin. The solid matter is cut by an ultramicrotome apparatus and a flaky sample with a thickness of 80 nm to 130 nm is prepared. As necessary, the flaky sample is colored using ruthenium tetroxide or the like in a desiccator at 30° C. Then, an SEM image of the flaky sample is obtained in an ultra-in high resolution field emission scanning electron microscope (for example, S-4800 manufactured by Hitachi High-Technologies Corporation). When toner particle cross-sections with various sizes are included in the SEM image, a toner particle cross-section where the long axis (the maximum length taken from two arbitrary points on the outline of the toner particle cross-section) is 85% or more of the volume average particle diameter of the toner particles is selected, a cross-section of 100 toner particles is randomly selected therefrom, and this cross-section is observed. In each of the 100 particles in the toner particle cross-section, the area of the layered inorganic material in all of the toner particles and the area of the layered inorganic material in the range of a depth of 5 nm to 20 nm from the toner particles surface are determined, and {area of layered inorganic material in the range of a depth of 5 nm to 20 nm from the toner particles surface÷area of layered inorganic material in all of the toner particles×100}(%) is calculated. Then, the average value of 100 particles in the toner particle cross-section is set as the surface layer presence ratio of the layered inorganic material (%).

### Other Coloring Agents

The toner particles may include coloring agents other than the brilliant pigment.

Examples of other coloring agents include pigments such as carbon black, chrome yellow, hansa yellow, benzidine yellow, threne yellow, quinoline yellow, pigment yellow, permanent orange GTR, pyrazolone orange, vulcan orange, watchung red, permanent red, brilliant carmine 3B, brilliant carmine 6B, Du Pont oil red, pyrazolone red, lithol red, rhodamine B lake, lake red C, pigment red, rose bengal, aniline blue, ultramarine blue, calco oil blue, methylene blue chloride, phthalocyanine blue, pigment blue, phthalocyanine green, and malachite green oxalate; dyes such as acridine dyes, xanthene dyes, azo dyes, benzoquinone dyes, azine dyes, anthraquinone dyes, thioindigo dyes, dioxazine dyes, thiazine dyes, azomethine dyes, indigo dyes, phthalocyanine dyes, aniline black dyes, polymethine dyes, triphenylmethane dyes, diphenylmethane dyes, and thiazole dyes.

Other coloring agents may be used as one type alone, or may be used in a combination of two or more types thereof.

As the other coloring agents, surface-treated coloring agents may be used as necessary, or may be used in together with dispersing agents. In addition, plural types of coloring agents may be used together.

In a case where another coloring agent is included in the toner particles, the content of the other coloring agent is preferably 1% by weight to 30% by weight with respect to all of the toner particles, and more preferably 3% by weight to 15% by weight.

### Release Agent

Examples of release agents include hydrocarbon wax; natural waxes such as carnauba wax, rice wax, and candelilla wax; synthetic or mineral and petroleum waxes such as montan wax; ester waxes such as fatty acid esters and montanic acid esters; and the like. The release agent is not limited thereto.

The melting temperature of the release agent is preferably from 50° C. to 110° C., and more preferably from 60° C. to 100° C. The melting temperature is determined according to the “melting peak temperature” described in the method for determining the melting temperature in “plastic transition temperature measurement method” in JIS K7121-1987 from a DSC curve obtained by differential scanning calorimetry (DSC).

The content of the release agent is preferably 1% by weight to 20% by weight with respect to all of the toner particles, and more preferably 5% by weight to 15% by weight.

### Other Additives

Examples of other additives include known additives such as magnetic material, charge-controlling agents, inorganic powder, and the like. These additives are included in the toner particles as internal additives.

### External Additives

Examples of external additives include inorganic particles, and the like. Examples of inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, MgSO₄, and the like.

The surface of the inorganic particles as the external additive may be subjected to a hydrophobic treatment. The hydrophobic treatment is performed, for example, by impregnating the inorganic particles in a hydrophobic treatment agent, or the like. The hydrophobizing agent is not particularly limited and examples thereof include a silane coupling agent, a silicone oil, a titanate coupling agent, an aluminum coupling agent, and the like. The above may be used alone, or may be used in a combination of two or more types thereof.

The amount of hydrophobizing agent is normally 1 parts by weight to 10 parts by weight with respect to 100 parts by weight of the inorganic particles.

Examples of external additives also include resin particles (resin particles such as polystyrene, poly methyl methacrylate, and melamine resin), cleaning aids (for example, metal salts of higher fatty acids represented by zinc stearate, and high molecular weight fluorine particles) and the like.

The externally added amount of the external additive is preferably 0.01% by weight to 5% by weight with respect to the toner particles, and more preferably 0.01% by weight to 2.0% by weight.

### Method for Preparing Toner Particles

The toner particles may be prepared by any of a drying method (for example, a kneading and pulverizing method or the like), or a wet method (for example, an aggregation coalescence method, a suspension polymerization method, a dissolution suspension method, or the like). The above methods are not particularly limited and a known method may be adopted.

The dissolution suspension method is a manufacturing method in which toner particles are obtained by removing an organic solvent after a liquid in which a binder resin and brilliant pigment is dissolved or dispersed in an organic solvent capable of dissolving a binder resin and a layered inorganic material are dispersed in an aqueous solvent which contains a dispersing agent. The layered inorganic material is dispersed in the organic solvent along with the binder resin and the brilliant pigment in advance. According to the dissolution suspension method, the layered inorganic material with high hydrophilicity is easily unevenly distributed in the toner particle surface layer.

The aggregation coalescence method is a manufacturing method in which toner particles are obtained through an aggregation step in which an aggregate of material of the toner particles is formed, and a coalescing step in which an aggregate is coalesced by heating. In the aggregation coalescence method, it is preferable that, after forming a first aggregate in which resin particles and a brilliant pigment are aggregated, a second aggregate in which resin particles and a layered inorganic material are aggregated on the surface of the first aggregate is formed and the second aggregate is coalesced by heating. A third aggregate in which resin particles are aggregated on the surface of the second aggregate may be formed and the third aggregate may be coalesced by heating.

Examples of methods for preparing toner particles including a urea-modified polyester resin as a binder resin include a dissolution suspension method and the like described below. In the following description, description will be given of a dissolution suspension method in which toner particles including an unmodified polyester resin and a urea-modified resin as a binder resin, and also including a release agent as an example.

### Oil Phase Liquid Preparation Step

An oil phase liquid in which an unmodified polyester resin, a polyester resin having an isocyanate group (referred to as a “polyester prepolymer”), an amine compound, a brilliant pigment, a layered inorganic material, and a release agent are dissolved or dispersed in an organic solvent is prepared (oil phase liquid preparation step). The layered inorganic material need not be included and may be added to the aqueous phase liquid along with the oil phase liquid.

In the oil phase liquid preparation step, for example, any one of the following is performed.

(i) All of the toner material is dissolved or dispersed in the organic solvent as a batch.

(ii) After kneading all of the material of the toner in advance, the kneaded product is dissolved or dispersed in the organic solvent.

(iii) An unmodified polyester resin, a polyester prepolymer, and an amine compound are dissolved in an organic solvent, then a brilliant pigment, a layered inorganic material, and a release agent are dispersed therein.

(iv) A brilliant pigment, a layered inorganic material, and a release agent are dispersed in an organic solvent, then an unmodified polyester resin, a polyester prepolymer, and an amine compound are dissolved therein.

(v) An unmodified polyester resin, a brilliant pigment, a layered inorganic material, and a release agent are dissolved or dispersed in an organic solvent, then a polyester prepolymer and amine compound are dissolved.

As the organic solvent of the oil phase liquid, an organic solvent in which a binder resin is dissolved, the dissolved amount in the water is 0% by weight to 30% by weight, and the boiling point is 100° C. is preferable. Examples of the organic solvent in the oil phase liquid include ester solvents such as methyl acetate and ethyl acetate; ketone solvents such as methyl ethyl ketone and methyl isopropyl ketone; aliphatic hydrocarbon solvents such as hexane and cyclohexane; halogenated hydrocarbon solvents such as dichloromethane, chloroform, trichlorethylene; and the like. Among these organic solvents, ethyl acetate is preferable.

### Suspension Preparation Step

A suspension is prepared by dispersing an oil phase liquid in an aqueous phase liquid (suspension preparation step).

The aqueous phase liquid is an aqueous solvent including a dispersing agent. The aqueous solvent has water as a main component and may include an organic solvent such as alcohol, dimethyl formamide, tetrahydrofuran, cellosolves, lower ketones, or the like. Examples of dispersing agents include resin particles such as poly (meth) acrylic acid alkyl ester resin, polystyrene resin, poly (styrene-acrylonitrile) resin, and polystyrene acrylic resin; and inorganic particles such as silica, alumina, titania, calcium carbonate, magnesium carbonate, tricalcium phosphate, clay, diatomaceous earth, and bentonite. Regarding these particle dispersing agents, the surfaces may be surface treated with a polymer which has a carboxyl group. In addition, examples of dispersing agents include polymer dispersing agents such as carboxymethyl cellulose, carboxyethyl cellulose, and the like.

After preparing the suspension, a reaction is carried out between the polyester prepolymer and amine compound. A urea-modified polyester resin is prepared by this reaction. This reaction is accompanied by at least one of a crosslinking reaction and an elongation reaction in the molecular chain. Here, the reaction between the polyester prepolymer and the amine compound may be performed in an organic solvent removing step to be described below.

In the reaction between the polyester prepolymer and amine compound, a catalyst (dibutyl tin laurate, dioctyl tin laurate, or the like) may be used as necessary. That is, the catalyst may be added to the oil phase liquid or suspension. The time for the reaction between the polyester prepolymer and the amine compound is preferably 10 minutes to 40 hours, and more preferably 2 hours to 24 hours. The reaction temperature is preferably 0° C. to 150° C., and more preferably 40° C. to 98° C.

### Solvent Removal Step

The toner particles are formed by removing the organic solvent from the suspension and a toner particle dispersion is obtained (solvent removal step). In the solvent removal step, the organic solvent is removed from the suspension by cooling or heating the suspension in a range of 0° C. to 100° C.

In the solvent removal step, for example, any one of the following operations is performed.

(i) The gas phase on the suspension surface is forcibly renewed by blowing a gas stream to the suspension. When this operation is performed, gas may be blown into the suspension.

(ii) The pressure is reduced at the periphery of the suspension. When this operation is performed, the gas phase may be forcibly renewed on the surface of the suspension due to the filling of the gas, or gas may be blown into the suspension.

Through the above steps, toner particles are obtained. After the solvent removal step is finished, the toner particles formed in the solution are subjected to a known cleaning step, a solid-liquid separation step, and a drying step to obtain toner particles in a dry state. In the cleaning step, from the point of view of the charging property, substitution cleaning may be sufficiently carried out using ion-exchange water. In the solid-liquid separation step, from the point of view of productivity, suction filtration, pressure filtration, or the like may be carried out. In the drying step, from the point of view of productivity, freeze drying, flash jet drying, fluidized drying, vibration fluidized drying, and the like may be carried out.

An external additive may be mixed with the toner particles in the dry state. The mixing of the external additive is performed using, for example, a V-BLENDER, a HENSCHEL MIXER, a LÖDIGE MIXER, or the like. Furthermore, as necessary, coarse particles of toner are removed using a vibration sieve machine, a wind classifier, or the like.

### Characteristics of Toner Particles

### Reflectivity of Image Formed by Brilliant Toner Particles

In a case where a solid image of brilliant toner particles is illuminated with light at a light incident angle of −45°, the ratio (X/Y) between the reflectivity λ of the light receiving angle of +30° and the reflectivity Y of the light receiving angle of −30° is preferably 1.2 to 100, more preferably 4 to 50, even more preferably 6 to 20, and still more preferably 8 to 15. When the ratio (X/Y) is less than 1.2, it is difficult to feel the brilliance when viewed with the reflected light. When the ratio (X/Y) exceeds 100, the viewing angle at which it is possible to view the reflected light is excessively narrowed, and, since the specular reflection light component is large, the image may appear dark according to the viewing angle.

The reflectivity X and the reflectivity Y are determined by the following method. A solid image formed using the brilliant toner particles is illuminated with light at a light incident angle of −45° using a variable angle photometer (spectroscopic variable angle color difference meter GC5000L of Nippon Denshoku Industries Co., Ltd.) and, for light of a wavelength of 400 nm to 700 nm, the reflectivity at a light receiving angle of +30° and the reflectivity at a light receiving angle of −30° are measured at 20 nm intervals. The average value of the reflectivity at a light receiving angle of +30° measured at 20 nm intervals is set as the reflectivity X and the average value of the reflectivity at a light receiving angle of −30° measured at 20 nm intervals is set as the reflectivity Y.

The brilliant toner particles preferably satisfy the following conditions from the point of view of satisfying the ratio (X/Y).

### Maximum Thickness C and Circle Equivalent Diameter D of Brilliant Toner Particles

The brilliant toner particles are preferably flake shape, and the circle equivalent diameter D is longer than the maximum thickness C. The ratio (C/D) of the maximum thickness C and the circle equivalent diameter D is preferably 0.001 to 0.5, more preferably 0.01 to 0.2, and even more preferably 0.05 to 0.1. The maximum thickness C and the circle equivalent diameter D of the brilliant toner particles are determined by the following method. The toner particles are put on a smooth surface and dispersed by applying vibration, three-dimensional data of 1,000 particles of toner particles is determined with a laser microscope (for example, VK-9700 manufactured by Keyence Corp.), the maximum thickness (L in FIG. 1) and the circle equivalent diameter (circle area equivalent diameter determined from a two-dimensional image at an angle at which the area is the largest) is analyzed, and the average values of 1,000 particles are set as the maximum thickness C and the circle equivalent diameter D.

### Angle of Long Axis Direction of Brilliant Toner Particles and Long Axis Direction of Brilliant Pigment

In a case where the cross-section of the brilliant toner particles in the thickness direction is observed, the number ratio of the brilliant pigment where the angle between the long axis direction of the brilliant toner particles and the long axis direction of the brilliant pigment is in a range of −30° to +30° is preferably 60% or more, more preferably 70% to 95%, and even more preferably 80% to 90%. The number ratio after embedding the toner particles in an epoxy resin, a flaky sample obtained by cutting using an ultramicrotome apparatus is observed using a high resolution field emission scanning electron microscope (for example, S-4800 manufactured by Hitachi High-Technologies Corporation), and the number ratio is determined by analyzing 100 particles in the toner particle cross-section.

The volume average particle diameter of the brilliant toner particles (D50v) is preferably 1 μm to 30 μm, and more preferably 3 μm to 20 μm.

### Carrier

The carrier is not particularly limited and examples thereof include known carriers. Examples of carriers include coated carriers in which a resin is coated on the surface of a core formed of a magnetic particle, magnetic particle-dispersed carriers in which magnetic particles are dispersed and blended in a matrix resin, resin-impregnated carriers in which a resin is impregnated with porous magnetic particles, and the like. The magnetic particle-dispersed carrier and the resin-impregnated carrier may be carriers in which the constituent particles of the carrier are set as a core and the surfaces thereof are coated with resin.

Examples of magnetic particles include magnetic metal such as iron, nickel, and cobalt; magnetic oxides such as ferrite, and magnetite; and the like.

Examples of coating resins and matrix resins include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylic acid copolymers, straight silicone resins or modified products thereof formed to include an organosiloxane bond, fluorine resins, polyesters, polycarbonate, phenol resins, epoxy resins, and the like. The coating resin and the matrix resin may include additives such as conductive particles. Examples of conductive particles include particles of metal such as gold, silver, and copper, carbon black, titanium oxide, zinc oxide, tin oxide, barium sulfate, aluminum borate, and potassium titanate.

For the coating of the surface of the core material with resin, examples include a method for coating using a coating layer forming solution in which the coating resin and the various types of additives (used as necessary) are dissolved in a suitable solvent, and the like. The solvent is not particularly limited and may be selected based on the type of resin to be used, the coating suitability, and the like. Specific examples of the resin coating method include an impregnation method in which a core material is impregnated in a coating layer forming solution; a spraying method in which a coating layer forming solution is sprayed onto a core material surface; a fluid bed method in which a coating layer forming solution is sprayed in a state where the core material is floating on fluid air; a kneader coater method in which the core material of the carrier and the coating layer forming solution are mixed in a kneader coater and then the solvent is removed; and the like.

The mixing ratio (weight ratio) of the toner (toner particles or external addition toner) and carrier in a two-component developer is preferably toner:carrier=1:100 to 30:100, and more preferably 3:100 to 20:100.

Detailed description will be given of each step of the image forming method according to the exemplary embodiment carried out using the electrostatic charge image developer as described above and each unit provided in the image forming apparatus according to the exemplary embodiment.

### Image Forming Method and Image Forming Apparatus

The image forming method according to the exemplary embodiment has a charging step in which a surface of an image holding member is charged; an electrostatic charge image forming step in which an electrostatic charge image is formed on the surface of the charged image holding member; a developing step in which the electrostatic charge image formed on the surface of the image holding member is developed as a toner image using an electrostatic charge image developer which includes brilliant toner particles; a transferring step in which the toner image formed on the surface of the image holding member is transferred onto a surface of a recording medium; and a fixing step in which the recording medium onto which the toner image is transferred is passed through a contact region between a fixing member and a pressing member is pressed to the fixing member to thereby fix the toner image, which is a brilliant image, on the surface of the recording medium.

The image forming apparatus according to the exemplary embodiment is provided with an image holding member; a charging unit which charges a surface of the image holding member; an electrostatic charge image forming unit which forms an electrostatic charge image on the surface of the charged image holding member; a developing unit which stores an electrostatic charge image developer which includes brilliant toner particles and which develops the electrostatic charge image formed on the surface of the image holding member as a toner image using an electrostatic charge image developer; a transfer unit which transfers the toner image formed on the surface of the image holding member onto a surface of a recording medium; and a fixing unit which has a fixing member and a pressing member is pressed to the fixing member, and passes the recording medium onto which the toner image is transferred through a contact region between the fixing member and the pressing member thereby fix the toner image, which is a brilliant image, on the surface of the recording medium.

The brilliant image satisfies conditions (1) and (2) described above.

For the image forming apparatus according to the exemplary embodiment, a known image forming apparatus is applied such as a direct transfer apparatus which transfers a toner image formed on the surface of the image holding member directly onto a recording medium; an intermediate transfer apparatus which primary transfers a toner image formed on the surface of an image holding member onto the surface of an intermediate transfer member and secondary transfers the toner image transferred onto the surface of the intermediate transfer member onto the surface of the recording medium; an apparatus provided with a cleaning unit which cleans the surface of the image holding member before charging after transferring the toner image; and an apparatus provided with a erasing unit which carries out erasing by irradiating the surface of an image holding member before charging with erasing light. In the case where the image forming apparatus according to the exemplary embodiment is an intermediate transfer apparatus, the transfer unit has, for example, an intermediate transfer member where a toner image is transferred onto a surface, a primary transfer unit which primary transfers a toner image formed on the surface of an image holding member onto the surface of an intermediate transfer member, and a secondary transfer unit which secondary transfers a toner image transferred onto the surface of the intermediate transfer member onto the surface of a recording medium. In the image forming apparatus according to the exemplary embodiment, for example, the portion which includes the developing unit may have a cartridge structure (process cartridge) which is detachable from the image forming apparatus.

The image forming method according to the exemplary embodiment is carried out by the image forming apparatus according to the exemplary embodiment. Below, description will be given of examples of the image forming apparatus and the image forming method according to the exemplary embodiment with reference to the drawings. FIG. 2 is a schematic configuration diagram showing an example of an image forming apparatus according to the exemplary embodiment.

An image forming apparatus 50 shown in FIG. 2 is provided with a photoreceptor 52 (an example of an image holding member) which rotates in a determined direction (the direction of the arrow F in FIG. 2). A charging device 54 (an example of a charging unit), an exposure device 56 (an example of an electrostatic charge image forming unit), a developing device 58 (an example of a developing unit), a transfer device 60 (an example of a transfer unit), and a cleaning member 62 (a cleaning unit for cleaning the residual toner on the image holding member surface) are provided on the periphery of the photoreceptor 52 in order along the rotational direction of the photoreceptor 52.

The charging device 54 charges the surface of the photoreceptor 52. The exposure device 56 exposes the surface of the photoreceptor 52 charged by the charging device 54 to form an electrostatic charge image. The developing device 58 stores a developer which includes brilliant toner particles and forms a toner image by developing an electrostatic charge image by supplying the developer to the surface of the photoreceptor 52. The transfer device 60 transfers the toner image formed on the photoreceptor 52 to the recording medium P by pinching and feeding the recording medium P between the transfer device 60 and the photoreceptor 52. The cleaning member 62 is disposed so as to contact with the surface of the photoreceptor 52 and removes the brilliant toner particles remaining on the surface of the photoreceptor 52.

The image forming apparatus 50 is provided with a fixing device 10. The recording medium P onto which the toner image is transferred by the transfer device 60 is fed to the fixing device 10 by a feeding mechanism (not shown) and the transferred toner image is fixed on the recording medium P by the fixing device 10.

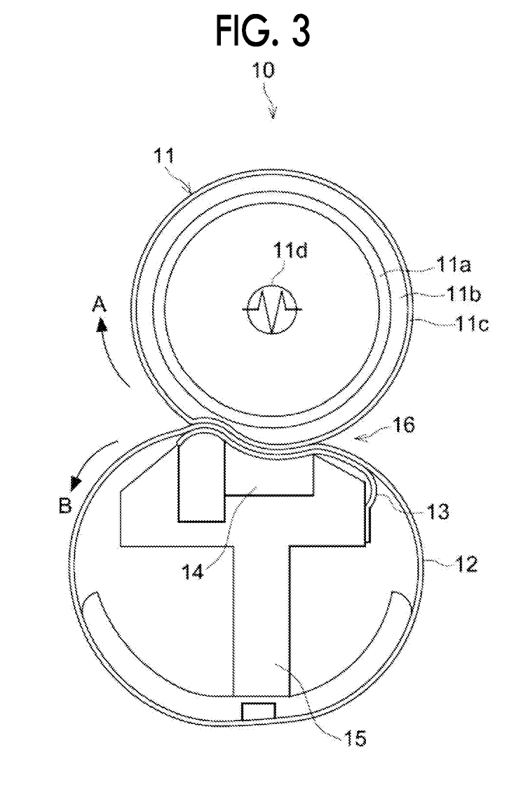

Description will be given of the fixing device 10. FIG. 3 is a side cross-sectional diagram which shows the configuration of the fixing device 10.

The fixing device 10 shown in FIG. 3 is provided with a fixing roll 11 (an example of a fixing member) which rotates in the direction of the arrow A, and a belt-shaped rotating member 12 (an example of a pressing member) which rotates in the direction of the arrow B by being driven by a fixing roll 11 while contacting with the fixing roll 11.

The fixing roll 11 is formed of a cylindrical core 11a, a heat-resistant elastic layer 11b formed on the outer peripheral surface of the cylindrical core 11a, a release layer 11c formed on the outer peripheral surface of the heat-resistant elastic layer 11b, and a heat source 11d disposed in the cylindrical core 11a. The fixing roll 11 prevents offset of the toner image through a release layer 11c which forms the outer peripheral surface.

The belt-shaped rotating member 12 is formed of a sliding sheet 13 which slides with the belt-shaped rotating member 12 while contacting with the inner peripheral surface of the belt-shaped rotating member 12, a pressing member 14 which presses the sliding sheet 13 onto the belt-shaped rotating member 12, and a support member 15 on which the pressing member 14 is mounted. A lubricant is present between the sliding sheet 13 and the belt-shaped rotating member 12. The belt-shaped rotating member 12 may be a member which is supported in a non-stretched state, or may be a member which is stretched and supported by being wrapped around plural rolls or the like.

The fixing device 10 is an device which fixes the toner image onto the recording medium by heating and pressing the recording medium (not shown) on which the toner image is held by pinching with a fixing nip 16. The fixing roll 11 and the belt-shaped rotating member 12 which form the fixing device 10 are rotated in the direction of the arrow A and the direction of the arrow B and heated to a determined temperature using the heat source 11d.

The fixing roll 11 is not particularly limited in relation to the shape, structure, size, and the like thereof and it is possible to select and use a fixing roll known in the related art. The fixing member is not limited to a roll-shape such as a fixing roll 11 and may have a belt shape as long as the fixing member is disposed to be able to rotate.

Examples of the material of the cylindrical core 11a forming the fixing roll 11 include metal alloys of aluminum, stainless steel, iron, copper, and the like, ceramics, fiber reinforced metal, and the like.

Examples of the material of the heat-resistant elastic layer 11b include silicone rubber, fluorine rubber, and the like. Among the above, silicone rubber is preferable from the point of view that the surface tension is small and the elasticity is excellent. Examples of silicone rubber include RTV silicone rubber, HTV silicone rubber, and the like, specifically, poly(dimethyl silicone) rubber, methyl vinyl silicone rubber, methyl phenyl silicone rubber, fluorosilicone rubber, and the like.

The thickness of the heat-resistant elastic layer 11b is, for example, 3 mm or less, and preferably 0.3 mm to 1.5 mm. The method for forming the heat-resistant elastic layer 11b on the outer peripheral surface of the cylindrical core 11a is not particularly limited, and it is possible to use a coating method or forming method known in the art.

The material of the release layer 11c is not particularly limited as long as the material exhibits releasability with respect to the toner image and examples thereof include fluorine rubber, silicone rubber, fluorine resin, and the like. Among these materials, fluorine resin is preferable. Examples of fluorine resins include tetrafluoroethylene-perfluoroalkyl vinyl ether copolymers, tetrafluoroethylene-perfluoromethyl vinyl ether copolymers, tetrafluoroethylene-perfluoroethyl vinyl ether copolymers, polytetrafluoroethylene, tetrafluoroethylene-hexafluoropropylene copolymers, polyethylene-tetrafluoroethylene, polyvinylidene fluoride, polychlorotrifluoroethylene, vinyl fluoride, or the like, and, from the point of view of heat resistance and mechanical characteristics, polytetrafluoroethylene, tetrafluoroethylene-perfluoroalkyl vinyl ether copolymers, tetrafluoroethylene-perfluoromethyl vinyl ether copolymers, or tetrafluoroethylene-perfluoroethylvinyl ether copolymer is preferably used.

The thickness of the release layer 11c is, for example, 10 μm to 100 μm, and preferably 20 μm to 40 μm. The method for forming the release layer 11c on the outer peripheral surface of the heat-resistant elastic layer 11b is not particularly limited and examples thereof include a coating method, and the like. In addition, examples include a method for coating a tube formed by extrusion forming and the like.

It is sufficient if the heat source 11d heats the fixing nip 16 and the heat source 11d is not limited to a unit for heating the fixing roll 11 from inside. That is, the unit for heating the fixing nip via the fixing member may of course be a unit for heating the fixing nip 16 by heating the belt-shaped rotating member 12 or the sliding sheet 13, and the fixing member itself may generate heat by electromagnetic induction.

The belt-shaped rotating member 12 is not particularly limited in relation to the shape, structure, size, and the like thereof and it is possible to select and use a rotating member known in the related art. The belt-shaped rotating member 12 is generally a belt formed in a band shape to be endless. The structure of the belt-shaped rotating member 12 may be a single layer structure, or may be a multi-layer structure. Examples of the belt-shaped rotating member 12 with a multi-layer structure include a belt having at least a base material layer and a release layer.

Examples of the material of the belt-shaped rotating member 12 include thermosetting polyimide, thermoplastic polyimide, polyamide, polyamide-imide, or the like. Among these, thermosetting polyimide is preferable from the point of view of excellent heat resistance, abrasion resistance, chemical resistance, and the like. Examples of the material of the release layer include fluorine resins such as tetrafluoroethylene-perfluoroalkyl vinyl ether copolymers, polytetrafluoroethylene, tetrafluoroethylene-hexafluoropropylene copolymers, polyethylene-tetrafluoroethylene, polyvinylidene fluoride, polychlorotrifluoroethylene, and vinyl fluoride; silicone rubber such as poly(dimethyl silicone) rubber, methyl vinyl silicone rubber, methyl phenyl silicone rubber, and fluorosilicone rubber; vinylidene fluoride rubber; tetrafluoroethylene-propylene rubber; fluorophosphazene rubber; fluorine rubber such as tetrafluoroethylene-perfluorovinyl ether rubber; and the like.

The sliding sheet 13 is pressed to the belt-shaped rotating member 12 via a lubricant. The sliding sheet 13 may have a single layer structure or may have a multi-layer structure. The sliding sheet 13 has, for example, in order from the sliding surface side, a non-conductive surface layer and a conductive base layer. The surface layer is preferably a non-porous material sheet formed of a heat-resistant resin from the point of view of preventing the permeation of the lubricant into the sliding sheet 13.

Examples of the heat-resistant resin forming the surface layer of the sliding sheet 13 include thermosetting polyimide, thermoplastic polyimide, polyamide, polyamide-imide, silicone resin, fluorine resin, and the like. Among these, a fluorine resin is preferable from the point of view of workability, friction characteristics, chemical affinity with the lubricant, and the like. Examples of fluorine resins include polytetrafluoroethylene, tetrafluoroethylene-perfluoroalkyl vinyl ether copolymers, modified products thereof, and the like from the point of view of workability, and friction characteristics.

The base material layer of the sliding sheet 13 is preferably formed of a base material having an uneven surface from the point of view of holding the lubricant. Examples of such base materials include porous sheets and examples of porous sheets include woven fabrics, non-woven fabric, porous resin sheets, and the like. Examples of the material of the porous sheet include polytetrafluoroethylene, tetrafluoroethylene-perfluoroalkyl vinyl ether copolymers, tetrafluoroethylene-hexafluoropropylene copolymers, glass fiber, aramid fiber, and the like, from the point of view of heat resistance, durability, and the like, and conductive fibers such as SUS fibers and carbon fibers may be interwoven in the fabric. A conductive filler may be mixed into the base material layer. Examples of conductive fillers include metal particles such as copper, copper alloy, silver, nickel, and low melting point alloy (solder, or the like); metal oxide particles such as zinc oxide, tin oxide, and indium oxide; carbon black; conductive polymer particles such as polypyrrole and polyaniline; metal-coated polymer particles; conductive fibers such as metal fibers and carbon fibers; and the like.

The pressing member 14 is a member of an elastic member and is mounted on a support member 15 to press the belt-shaped rotating member 12 against the fixing roll 11 via the sliding sheet 13. The pressing member 14 is fixed and disposed to press the belt-shaped rotating member 12 toward the fixing roll 11. From the point of view of preventing deterioration due to heat at the time of fixing, the material of the pressing member 14 is preferably a material having heat resistance.

From the point of view of hardness and heat stability, silicone rubber with a durometer hardness of A10° to A40° is suitable for use as the material of the elastic member of the pressing member 14. The shape, structure, size, and the like of the pressing member 14 are not particularly limited and may be selected from the related art. The pressing member 14 may have a structure formed of a single member, or may have a structure formed of plural members.

Examples of the lubricant which is present between the sliding sheet 13 and the belt-shaped rotating member 12 include fluorine grease, dimethyl silicone oil, organic metal salt additive dimethyl silicone oil, hindered amine-added dimethyl silicone oil, organic metal salts and hindered amine-added dimethyl silicone oil, methylphenyl silicone oil, organic metal salt additive amino-modified silicone oil, hindered amine-added amino-modified silicone oil, perfluoropolyethyl oil, modified perfluoropolyethyl oil, modified perfluoropolyethyl oil-containing perfluoropolyethyl oil, and the like. The lubricant is preferably silicone oil from the point of view of the lubricity, heat resistance, volatility, and the like, more preferably amino-modified silicone oil from the point of view of excellent wettability, and methyl phenyl silicone oil is more preferable from the point of view of superior heat resistance. an antioxidant may be added into the silicone oil in order to improve the heat resistance, and an amine-modified silicone oil containing an organometallic (titanate) antioxidant is preferable from the point of view of heat resistance and lack of thermal degradation. In a case where silicone oil is used as a lubricant, it is preferable that the viscosity thereof is 50 centistokes to 3,000 centistokes at normal temperature.

The recording medium onto which the toner image is transferred is inserted into a fixing nip 16 formed by pressing contact between the fixing roll 11 and the belt-shaped rotating member 12. At this time, the recording medium is inserted such that the surface onto which the toner image on the recording medium is transferred faces the outer peripheral surface of the fixing roll 11. When the recording medium passes through the fixing nip 16, a toner image is fixed to the recording medium by the application of heat and pressure to the toner image on the recording medium.

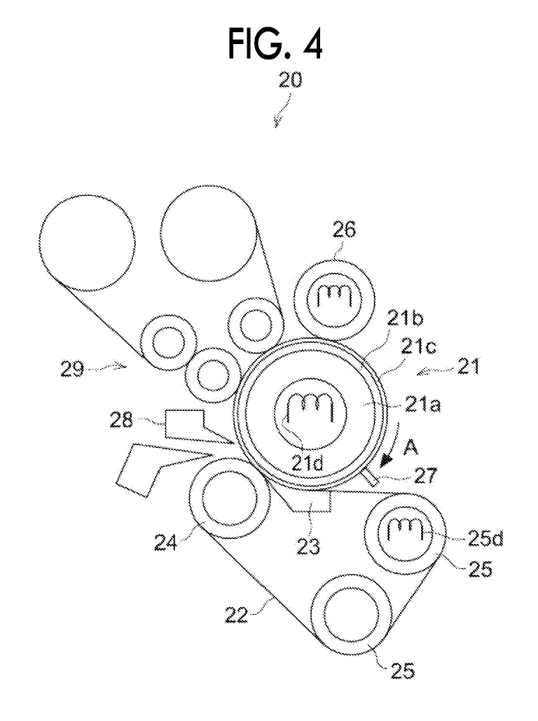

Description will be given of another embodiment where the image forming apparatus 50 is provided with a fixing device. FIG. 4 is a side cross-sectional diagram which shows the configuration of the fixing device 20. The fixing device 20 is disposed in place of the fixing device 10 in the image forming apparatus 50.

The fixing device 20 shown in FIG. 4 is provided with a heating roll 21 (an example of a fixing member) which rotates in the direction of the arrow A, and a pressing belt 22 which contacta with the heating roll 21 (an example of a pressing member).

The heating roll 21 is provided with a hollow roll 21a made of metal, a heat-resistant elastic layer 21b disposed on the outer peripheral surface of the hollow roll 21a, a release layer 21c disposed on the outer peripheral surface of the heat-resistant elastic layer 21b, and a heat source 21d such as a heater lamp disposed in the hollow roll 21a. The heating roll 21 prevents offset of the toner image by the release layer 21c forming the outer peripheral surface.

An external heating device 26 for heating the heating roll 21 from the outer peripheral surface side, a temperature sensor 27 for controlling the temperature of the heating roll 21 surface, a peeling member 28 for peeling the recording medium from the heating roll 21 after fixing, and a cleaning device 29 for cleaning the heating roll 21 surface are provided around the heating roll 21 in order in the direction of rotation (in the direction of the arrow A).

A pressure pad 23 and a pressure roll 24 for pressing the pressing belt 22 onto the heating roll 21, and two support rolls 25 are arranged within the circumference of the pressing belt 22. The pressing belt 22 is stretched between one pressure roll 24 and the two support rolls 25. At least one of the two support rolls 25 may have a heat source 25d such as a heater lamp in the inside thereof.

The pressing belt 22 may have a single layer structure, and may have a multi-layer structure. Examples of the pressing belt 22 with the multi-layer structure include a belt which has at least a heat-resistant elastic layer and a release layer. Specific examples of the pressing belt 22 include a belt where a release layer formed of a vulcanizate of a fluorine resin particle-containing rubber composition is disposed on the outer peripheral surface of an endless belt made of polyimide.

In the pressure pad 23, the shape of the contact portion with pressing belt 22 is a shape which is in close contact without gaps with the inner peripheral surface of the pressing belt 22. Examples of the material of the pressure pad 23 include heat-resistant resin such as polyimide; heat-resistant rubber such as silicone rubber, fluorosilicone rubber, and fluorine rubber; and the like.

The recording medium onto which the toner image is transferred is inserted into the fixing nip formed by the pressing contact of the heating roll 21 and the pressing belt 22. At this time, the recording medium is inserted such that the surface onto which the toner image is transferred onto the recording medium faces the outer peripheral surface of the heating roll 21. When the recording medium passes through the fixing nip, a toner image is fixed to the recording medium by the application of heat and pressure to the toner image on the recording medium.

In the exemplary embodiment, in order to fix the brilliant image which meets condition (1) and condition (2), the conditions of the fixing process carried out by the fixing device as shown in FIG. 3 and FIG. 4 are preferably set to the following ranges.
The temperature of the surface of the fixing member is preferably 110° C. to 180° C. When the temperature is 110° C. or higher, a preferable image gloss is obtained. When the temperature is 180° C. or lower, the resin is not excessively softened and, as a result, the arrangement of the pigment is good and the image gloss is excellent. From this point of view, the temperature of the fixing member surface is more preferably 130° C. to 170° C.
The fixing pressure is preferably 0.4 kgf/cm² to 5 kgf/cm². When the fixing pressure is 0.4 kgf/cm² or more, the arrangement of the pigment is preferable. When the fixing pressure is 5 kgf/cm² or less, the arrangement of the toner during fixing is favorable. From this point of view, the fixing pressure is more preferably 0.8 kgf/cm² to 3 kgf/cm².
The nip width (the length along the feeding direction of the recording medium) is preferably 1 mm to 10 mm. When the nip width is 1 mm or more, the recording medium is susceptible to heat from the fixing members necessary for fixing. When the nip width is 10 mm or less, the resin is not excessively softened. From this point of view, the nip width is more preferably 3 mm to 8 mm.
The feeding speed of the recording medium is preferably 10 mm/sec to 200 mm/sec. When the feeding speed is 10 mm/sec or more, it is possible to prevent the excessive softening of the resin. When the feeding speed is 200 mm/sec or less, it is possible to prevent roughness in the unfixed image during fixing. From this point of view, the feeding speed of the recording medium is more preferably 50 mm/sec to 160 mm/sec.

### Examples

Detailed description will be given below of an embodiment of the invention using Examples; however, the embodiment of the invention is not limited to any of the Examples. In the following description, “parts” and “%” are based on weight unless otherwise noted.

### Preparation of Unmodified Polyester Resin (A1)]

Terephthalic acid: 1243 parts
Bisphenol A ethylene oxide adduct: 1830 parts
Bisphenol A propylene oxide adduct: 840 parts

After the materials described above are mixed while heating at 180° C., 3 parts of dibutyl tin oxide are added, water is distilled off while heating at 220° C., and an unmodified polyester resin (A1) is obtained. The glass transition temperature Tg of the unmodified polyester resin (A1) is 60° C.

### Preparation of Polyester Prepolymer (A1)]

Terephthalic acid: 1243 parts
Bisphenol A ethylene oxide adduct: 1830 parts
Bisphenol A propylene oxide adduct: 840 parts

After the materials described above are mixed while heating at 180° C., 3 parts of dibutyl tin oxide are added, water is distilled off while heating at 220° C., and an polyester resin is obtained. 350 parts of the polyester resin, 50 parts of tolylene diisocyanate, and 450 parts of ethyl acetate are mixed in a container, heated for 3 hours at 130° C., and a polyester prepolymer (A1) which has an isocyanate group is obtained.

### Preparation of Ketimine Compound (A1)]

50 parts of methyl ethyl ketone and 150 parts of hexamethylene diamine are put into a container and a ketimine compound (A1) is obtained by stirring at 60° C.

### Preparation of Brilliant Pigment Dispersion (A1)]

10 parts of a flake shape aluminum pigment (manufactured by Toyo Aluminum Co., Ltd., average length in the long axis direction of 5 μm, average length in the thickness direction of 0.6 μm) are dispersed in 50 parts of ethyl acetate and then filtered. After repeating the operations of the dispersion and filtration 5 times, the filtrate is poured into 50 parts of ethyl acetate, a dispersion process is performed for one hour using an emulsion dispersing machine (CAVITRON CR1010 manufactured by Pacific Machinery & Engineering Co., Ltd), the solid concentration is adjusted, and a brilliant pigment dispersion (A1) (solid concentration 10%) is obtained.

### Preparation of Layered Inorganic Material Dispersion (A1)]

50 parts of montmorillonite (NANOMER 1.28E manufactured by Sigma-Aldrich Co. LLC, average length in the long axis direction of 2.0 μm, aspect ratio of 30 to 60) are dispersed in 50 parts of ethyl acetate and then filtered. After repeating the operations of the dispersion and filtration 5 times, the filtrate is poured into 50 parts of ethyl acetate, a dispersion process is performed for one hour using an emulsion dispersing machine (CAVITRON CR1010 manufactured by Pacific Machinery & Engineering Co., Ltd), the solid concentration is adjusted, and a layered inorganic material dispersion (A1) (solid concentration 33.3%) is obtained.

### Preparation of Release Agent Dispersion (A1)]

Paraffin wax (melting temperature 89° C.): 30 parts
Ethyl acetate: 270 parts

In a state where the materials described above are cooled to 10° C., wet milling is carried out using a micro-beads dispersing machine (DCP mill), and a release agent dispersion (A1) (solid concentration 10%) is obtained.

### Preparation of Styrene-Acrylic Resin Particle Dispersion (A1)]

Styrene: 332 parts
n-butyl acrylate: 68 parts
Acrylic acid: 4 parts
Dodecanethiol: 8 parts
Carbon tetrabromide: 4 parts

A solution in which 6 parts of a non-ionic surfactant (NONIPOL 400 manufactured by Sanyo Chemical Industries) and 10 parts of an anionic surfactant (NEOGEN SC manufactured by DKS Co., Ltd) are dissolved in 560 parts of ion-exchange water is prepared in a flask, and a mixture of the materials described above is dispersed and emulsified in the solution in the flask. Next, while stirring in the flask, a solution in which 4 parts of ammonium persulfate are dissolved in 50 parts of ion-exchanged water is added thereto, and nitrogen substitution is performed. Next, the contents are heated up to 70° C. in an oil bath while stirring the inside of the flask, emulsion polymerization is continued for 5 hours, and a styrene-acrylic resin particle dispersion (A1) (volume average particle diameter of the resin particles of 180 nm and a solid concentration of 40%) is obtained. The styrene-acrylic resin has a glass transition point 59° C. and a weight average molecular weight of 15500.

### Preparation of Oil Phase Liquid (A1)]

Unmodified polyester resin (A1): 60 parts
Brilliant pigment dispersion (A1): 52 parts (solid content concentration: 10%)
Release agent dispersion (A1): 70 parts (solid content concentration: 10%)
Ethyl acetate: 30 parts

After stirring and mixing the ethyl acetate, unmodified polyester resin (A1) and brilliant pigment dispersion (A1), the release agent dispersion (A1) is added to the mixture, and an oil phase liquid (A1) is obtained by further stirring.

### Preparation of Oil Phase Liquid (A2)]

An oil phase liquid (A2) is prepared in the same manner as in the preparation of the oil phase liquid (A1) except that 64 parts of the unmodified polyester resin (A1) and 48 parts of the brilliant pigment dispersion (A1) are used in the preparation of the oil phase liquid (A1).

### Preparation of Oil Phase Liquid (A3)]

An oil phase liquid (A3) is prepared in the same manner as in the preparation of the oil phase liquid (A1) except that 80 parts of the unmodified polyester resin (A1) and 32 parts of the brilliant pigment dispersion (A1) are used in the preparation of the oil phase liquid (A1).

### Preparation of Oil Phase Liquid (A4)]

An oil phase liquid (A4) is prepared in the same manner as in the preparation of the oil phase liquid (A1) except that 84 parts of the unmodified polyester resin (A1) and 28 parts of the brilliant pigment dispersion (A1) are used in the preparation of the oil phase liquid (A1).

### Preparation of Oil Phase Liquid (A5)]

An oil phase liquid (A5) is prepared in the same manner as in the preparation of the oil phase liquid (A1) except that 92 parts of the unmodified polyester resin (A1) and 20 parts of the brilliant pigment dispersion (A1) are used in the preparation of the oil phase liquid (A1).

### Preparation of Oil Phase Liquid (A6)]

An oil phase liquid (A6) is prepared in the same manner as in the preparation of the oil phase liquid (A1) except that 101 parts of the unmodified polyester resin (A1) and 10 parts of the brilliant pigment dispersion (A1) are used in the preparation of the oil phase liquid (A1).

### Preparation of Oil Phase Liquid (A7)]

An oil phase liquid (A7) is prepared in the same manner as in the preparation of the oil phase liquid (A1) except that 102 parts of the unmodified polyester resin (A1) and 5 parts of the brilliant pigment dispersion (A1) are used in the preparation of the oil phase liquid (A1).

### Preparation of Oil Phase Liquid (A8)]

An oil phase liquid (A8) is prepared in the same manner as in the preparation of the oil phase liquid (A1) except that 106 parts of the unmodified polyester resin (A1) and 1 part of the brilliant pigment dispersion (A1) are used in the preparation of the oil phase liquid (A1).

### Preparation of Aqueous Phase Liquid (A1)]

Styrene acrylic resin particle dispersion (A1): 50 parts (solid content concentration: 40%)
Polymer dispersing agent: 200 parts (2% aqueous solution of CELLOGEN BS-H (manufactured by DKS Co., Ltd))
Ion-exchange water: 200 parts

The materials described above are stirred and mixed and an aqueous phase liquid (A1) is obtained.

### Preparation of Brilliant Toner Particles (A1)

Oil phase liquid (A1): 1200 parts
Polyester prepolymer (A1): 150 parts
Ketimine compound (A1): 10 parts
Layered inorganic material dispersion (A1): 0.012 parts (solid content concentration of 33.3%)

The materials described above are put in a container, a dispersion process is performed for two minutes in a homogenizer (Ultra TURRAX manufactured by IKA Works GmbH.), an oil phase liquid (A1P) is obtained. 1,000 parts of the aqueous phase liquid (A1) are added to the oil phase liquid (A1P), a dispersion process is performed for 20 minutes in a homogenizer, and a suspension is obtained. Next, the suspension is stirred with a propeller stirrer for 48 hours under atmospheric pressure (1 atm) at room. temperature (25° C.), polyester prepolymer (A1) and ketimine compound (A1) are reacted, a urea-modified polyester resin is formed, the organic solvent is removed, and a granulate is formed. Next, the granulate is cleaned with water, dried, and classified to obtain brilliant toner particles (A1). The volume average particle diameter of the brilliant toner particles (A1) is 15 μm.

### Preparation of Brilliant Toner Particles (A2)

Brilliant toner particles (A2) with a volume average particle diameter of 12 μm are obtained in the same manner as in the preparation of the brilliant toner particles (A1) except that the oil phase liquid (A2) is used and 0.019 parts of the layered inorganic material dispersion (A1) are used.

### Preparation of Brilliant Toner Particles (A3)

Brilliant toner particles (A3) with a volume average particle diameter of 11 μm are obtained in the same manner as in the preparation of the brilliant toner particles (A1) except that the oil phase liquid (A3) is used and 0.030 parts of the layered inorganic material dispersion (A1) are used.

### Preparation of Brilliant Toner Particles (A4)

Brilliant toner particles (A4) with a volume average particle diameter of 10 μm are obtained in the same manner as in the preparation of the brilliant toner particles (A1) except that the oil phase liquid (A4) is used and 0.039 parts of the layered inorganic material dispersion (A1) are used.

### Preparation of Brilliant Toner Particles (A5)

Brilliant toner particles (A5) with a volume average particle diameter of 9 μm are obtained in the same manner as in the preparation of the brilliant toner particles (A1) except that the oil phase liquid (A5) is used and 0.19 parts of the layered inorganic material dispersion (A1) are used.

### Preparation of Brilliant Toner Particles (A6)

Brilliant toner particles (A6) with a volume average particle diameter of 12 μm are obtained in the same manner as in the preparation of the brilliant toner particles (A1) except that the oil phase liquid (A5) is used and 0.38 parts of the layered inorganic material dispersion (A1) are used.

### Preparation of Brilliant Toner Particles (A7)

Brilliant toner particles (A7) with a volume average particle diameter of 9 μm are obtained in the same manner as in the preparation of the brilliant toner particles (A1) except that the oil phase liquid (A6) is used and 1.20 parts of the layered inorganic material dispersion (A1) are used.

### Preparation of Brilliant Toner Particles (A8)

Brilliant toner particles (A8) with a volume average particle diameter of 12 μm are obtained in the same manner as in the preparation of the brilliant toner particles (A1) except that the oil phase liquid (A6) is used and 1.89 parts of the layered inorganic material dispersion (A1) are used.

### Preparation of Brilliant Toner Particles (A9)

Brilliant toner particles (A9) with a volume average particle diameter of 10 μm are obtained in the same manner as in the preparation of the brilliant toner particles (A1) except that the oil phase liquid (A7) is used and 3.0 parts of the layered inorganic material dispersion (A1) are used.

### Preparation of Brilliant Toner Particles (A10)

Brilliant toner particles (A10) with a volume average particle diameter of 12 μm are obtained in the same manner as in the preparation of the brilliant toner particles (A1) except that the oil phase liquid (A7) is used and 3.8 parts of the layered inorganic material dispersion (A1) are used.

Preparation of Brilliant Toner Particles (all)

Brilliant toner particles (A11) with a volume average particle diameter of 12 μm are obtained in the same manner as in the preparation of the brilliant toner particles (A1) except that the oil phase liquid (A8) is used and 4.8 parts of the layered inorganic material dispersion (A1) are used.

### Preparation of Brilliant Toner Particles (A12)

Brilliant toner particles (A12) with a volume average particle diameter of 14 μm are obtained in the same manner as in the preparation of the brilliant toner particles (A1) except that the oil phase liquid (A8) is used and 6.0 parts of the layered inorganic material dispersion (A1) are used.

### Preparation of Polyester Resin (B1)]

Dimethyl adipate: 74 parts
Dimethyl terephthalate: 192 parts
Bisphenol A ethylene oxide adduct: 216 parts
Ethylene glycol: 38 parts
Tetrabutoxytitanate (catalyst): 0.037 parts

After the materials described above are put in a two-necked heated and dried flask, nitrogen gas is introduced into the container, and the result is heated while stirring and preserving an inert atmosphere, a condensation polymerization reaction is carried out for 7 hours at 160° C., then the resultant is heated to 220° C. and held for 4 hours while slowly reducing the pressure to 10 Torr. Next, the pressure is returned to normal pressure, 9 parts of trimellitic anhydride are added, the pressure is slowly reduced to 10 Torr again, the resultant is held for one hour at 220° C. and a polyester resin (B1) is obtained. The glass transition temperature (Tg) of the polyester resin (B1) is 64° C.

### Preparation of Resin Particle Dispersion (B1)]

Polyester resin (B1): 160 parts
Ethyl acetate: 233 parts
Sodium hydroxide solution (0.3N): 0.1 parts

The materials described above are put into a 1 L separable flask and heated at 70° C., and a resin mixture is prepared by stirring with a three-one motor (manufactured by Shinto Scientific Co., Ltd.). While further stirring the resin mixture at 90 rpm, 373 parts of ion-exchange water are slowly added, phase inversion emulsification is carried out, the solvent is removed, and a resin particle dispersion (B1) (solid concentration: 30%) is obtained.

### Preparation of Brilliant Pigment Dispersion (B1)]

Flake shape aluminum pigment (2173EA manufactured by Toyo Aluminum): 100 parts
Anionic surfactant (NEOGEN R manufactured by DKS Co., Ltd.): 1.5 parts
Ion-exchange water: 900 parts

The materials described above are mixed, a dispersion process is performed for one hour using an emulsion dispersing machine (CAVITRON CR1010 manufactured by Pacific Machinery & Engineering Co., Ltd), and a brilliant pigment dispersion (B1) (solid concentration 10%) is obtained.

### Preparation of Release Agent Dispersion (B1)]

Carnauba wax (RC-160 manufactured by Toa Chemical Industry): 50 parts
Anionic surfactant (NEOGEN RK manufactured by DKS Co., Ltd.): 1.0 parts
Ion-exchange water: 200 parts

The materials described above are mixed and heated to 95° C., a dispersion process is performed using homogenizer (Ultra-Turrax T50 manufactured by IKA), then, a dispersion process is performed for 360 minutes using a Manton-Gaulin high-pressure homogenizer (Gaulin), and a release agent dispersion (B1) (solid concentration: 20%) is obtained. The volume average particle diameter of the release agent particles in the release agent dispersion (B1) is 230 nm.

### Preparation of Layered Inorganic Material Dispersion (B1)]

Montmorillonite (NANOMER 1.28E Sigma-Aldrich): 100 parts
Anionic surfactant (NEOGEN R manufactured by DKS Co., Ltd.): 1.5 parts
Ion-exchange water: 900 parts

The materials described above are mixed, a dispersion process is performed for one hour using an emulsion dispersing machine (CAVITRON CR1010 manufactured by Pacific Machinery & Engineering Co., Ltd), and a layered inorganic material dispersion (B1) (solid concentration 10%) is obtained.

### Preparation of Brilliant Toner Particles (B1)

Resin particle dispersion (B1): 500 parts (solid content concentration 30%)
Brilliant pigment dispersion (B1): 350 parts (solid content concentration: 10%)
Release agent dispersion (B1): 50 parts (solid content concentration 20%)
Non-ionic surfactant (IgepalCA897): 1.40 parts

The raw materials described above are put in a 2 L cylindrical stainless steel container (diameter 30 cm), and a dispersion process is performed for 10 minutes while applying a shearing force at 4,000 rpm using a homogenizer (ULTRA-Turrax T50 manufactured by IKA). Next, 1.75 parts of a 10% aqueous solution of poly aluminum chloride is slowly added dropwise, a dispersion process is performed for 15 minutes in a homogenizer with a rotation speed of 5,000 rpm, and a raw material dispersion is obtained. Next, the raw material dispersion is transferred to a polymerization kettle provided with a stirrer, which has two paddle stirring blades, and a thermometer, heating is started in a mantle heater while stirring at a rotation speed of 1200 rpm, and a first aggregation is formed by holding the result at 54° C. for 2 hours. At the time, the pH of the raw material dispersion is controlled to be 2.2 to 3.5 with a 0.3N nitric acid and 1N aqueous sodium hydroxide solution. Next, 23 parts of the layered inorganic material dispersion (B1) and the 100 parts of the resin particle dispersion (B1) are further added thereto, the layered inorganic material and the resin particles are attached to the surface of the first aggregation and a second aggregation is formed. Next, the temperature is raised to 56° C. and held for two hours while confirming the form and size of the second aggregation with an optical microscope and a Multisizer II (Beckman Coulter). Next, after raising the pH to 8.0, the temperature is heated to 67.5° C., the second aggregate is coalesced, the pH is lowered to 6.0 while holding the temperature at 67.5° C., the heating is stopped after 1 hour, and the temperature is cooled at a speed of 0.1° C. per minute. Next, after sieving with a 20 μm mesh and repeatedly cleaning with water, toner particles (B1) are obtained by drying with a vacuum dryer. The volume average particle diameter of the toner particles (B1) is 9 μm.

### Preparation of Brilliant Toner Particles (B2)

Brilliant toner particles (B2) with a volume average particle diameter of 15 μm are obtained with the same method as for the preparation of the brilliant toner particles (B1) except that the resin particle dispersion (B1) to be mixed first is set to 400 parts and the resin particle dispersion (B1) to be additionally added is set to 200 parts.

### Preparation of Brilliant Toner Particles (B3)

Brilliant toner particles (B3) with a volume average particle diameter of 15 μm are obtained with the same method as for the preparation of the brilliant toner particles (B1) except that the resin particle dispersion (B1) to be mixed first is set to 420 parts and the resin particle dispersion (B1) to be added is set to 180 parts.

### Preparation of Brilliant Toner Particles (B4)

Brilliant toner particles (B4) with a volume average particle diameter of 12 μm are obtained with the same method as for the preparation of the brilliant toner particles (B1) except that the resin particle dispersion (B1) to be mixed first is set to 440 parts and the resin particle dispersion (B1) to be added is set to 160 parts.

### Preparation of Brilliant Toner Particles (B5)

Brilliant toner particles (B5) with a volume average particle diameter of 11 μm are obtained with the same method as for the preparation of the brilliant toner particles (B1) except that the resin particle dispersion (B1) to be mixed first is set to 460 parts and the resin particle dispersion (B1) to be added is set to 140 parts.

### Preparation of Brilliant Toner Particles (B6)

Brilliant toner particles (B6) with a volume average particle diameter of 11 μm are obtained with the same method as for the preparation of the brilliant toner particles (B1) except that the resin particle dispersion (B1) to be mixed first is set to 480 parts and the resin particle dispersion (B1) to be added is set to 120 parts.

### Preparation of Brilliant Toner Particles (B7)

Brilliant toner particles (B7) with a volume average particle diameter of 10 μm are obtained with the same method as for the preparation of the brilliant toner particles (B1) except that the resin particle dispersion (B1) to be mixed first is set to 520 parts and the resin particle dispersion (B1) to be added is set to 80 parts.

### Preparation of Brilliant Toner Particles (B8)

Brilliant toner particles (B8) with a volume average particle diameter of 15 μm are obtained with the same method as for the preparation of the brilliant toner particles (B1) except that the resin particle dispersion (B1) to be mixed first is set to 540 parts and the resin particle dispersion (B1) to be added is set to 60 parts.

### Preparation of Brilliant Toner Particles (B9)

Brilliant toner particles (B9) with a volume average particle diameter of 16 μm are obtained with the same method as for the preparation of the brilliant toner particles (B1) except that the resin particle dispersion (B1) to be mixed first is set to 560 parts and the resin particle dispersion (B1) to be added is set to 40 parts.

### Preparation of Brilliant Toner Particles (B10)

Brilliant toner particles (B10) with a volume average particle diameter of 16 μm are obtained with the same method as for the preparation of the brilliant toner particles (B1) except that the resin particle dispersion (B1) to be mixed first is set to 570 parts, the brilliant pigment dispersion (B1) is set to 250 parts, and the resin particle dispersion (B1) to be added is set to 130 parts.

### Preparation of Brilliant Toner Particles (B11)

Brilliant toner particles (B11) with a volume average particle diameter of 15 μm are obtained with the same method as for the preparation of the brilliant toner particles (B1) except that the resin particle dispersion (B1) to be mixed first is set to 556 parts, the brilliant pigment dispersion (B1) is set to 270 parts, and the resin particle dispersion (B1) to be added is set to 124 parts.

### Preparation of Brilliant Toner Particles (B12)

Brilliant toner particles (B12) with a volume average particle diameter of 13 μm are obtained with the same method as for the preparation of the brilliant toner particles (B1) except that the resin particle dispersion (B1) to be mixed first is set to 542 parts, the brilliant pigment dispersion (B1) is set to 290 parts, and the resin particle dispersion (B1) to be added is set to 118 parts.

### Preparation of Brilliant Toner Particles (B13)

Brilliant toner particles (B13) with a volume average particle diameter of 12 μm are obtained with the same method as for the preparation of the brilliant toner particles (B1) except that the resin particle dispersion (B1) to be mixed first is set to 528 parts, the brilliant pigment dispersion (B1) is set to 310 parts, and the resin particle dispersion (B1) to be added is set to 112 parts.

### Preparation of Brilliant Toner Particles (B14)

Brilliant toner particles (B14) with a volume average particle diameter of 11 μm are obtained with the same method as for the preparation of the brilliant toner particles (B1) except that the resin particle dispersion (B1) to be mixed first is set to 514 parts, the brilliant pigment dispersion (B1) is set to 330 parts, and the resin particle dispersion (B1) to be added is set to 106 parts.

### Preparation of Brilliant Toner Particles (B15)

Brilliant toner particles (B15) with a volume average particle diameter of 10 μm are obtained with the same method as for the preparation of the brilliant toner particles (B1) except that the resin particle dispersion (B1) to be mixed first is set to 486 parts, the brilliant pigment dispersion (B1) is set to 370 parts, and the resin particle dispersion (B1) to be added is set to 94 parts.

### Preparation of Brilliant Toner Particles (B16)

Brilliant toner particles (B16) with a volume average particle diameter of 12 μm are obtained with the same method as for the preparation of the brilliant toner particles (B1) except that the resin particle dispersion (B1) to be mixed first is set to 472 parts, the brilliant pigment dispersion (B1) is set to 390 parts, and the resin particle dispersion (B1) to be added is set to 88 parts.

### Preparation of Brilliant Toner Particles (B17)

Brilliant toner particles (B17) with a volume average particle diameter of 11 μm are obtained with the same method as for the preparation of the brilliant toner particles (B1) except that the resin particle dispersion (B1) to be mixed first is set to 458 parts, the brilliant pigment dispersion (B1) is set to 410 parts, and the resin particle dispersion (B1) to be added is set to 82 parts.

### Preparation of Brilliant Toner Particles (B18)

Brilliant toner particles (B18) with a volume average particle diameter of 15 μm are obtained with the same method as for the preparation of the brilliant toner particles (B1) except that the layered inorganic material dispersion (B1) is set to 8 parts.

### Preparation of Brilliant Toner Particles (B19)

Brilliant toner particles (B19) with a volume average particle diameter of 11 μm are obtained with the same method as for the preparation of the brilliant toner particles (B1) except that the layered inorganic material dispersion (B1) is set to 13 parts.

### Preparation of Brilliant Toner Particles (B20)

Brilliant toner particles (B20) with a volume average particle diameter of 10 μm are obtained with the same method as for the preparation of the brilliant toner particles (B1) except that the layered inorganic material dispersion (B1) is set to 18 parts.

### Preparation of Brilliant Toner Particles (B21)

Brilliant toner particles (B21) with a volume average particle diameter of 9 μm are obtained with the same method as for the preparation of the brilliant toner particles (B1) except that the layered inorganic material dispersion (B1) is set to 28 parts.

### Preparation of Brilliant Toner Particles (B22)

Brilliant toner particles (B22) with a volume average particle diameter of 9 μm are obtained with the same method as for the preparation of the brilliant toner particles (B1) except that the layered inorganic material dispersion (B1) is set to 33 parts.

### Preparation of Brilliant Toner Particles (B23)

Brilliant toner particles (B23) with a volume average particle diameter of 15 μm are obtained with the same method as for the preparation of the brilliant toner particles (B1) except that the layered inorganic material dispersion (B1) is set to 38 parts.

### Preparation of Developer>

### Preparation of External Addition Toner

100 parts of any of the brilliant toner particles (A1) to (A12) and the brilliant toner particles (B1) to (B23) and 1.5 parts of hydrophobic silica (Japan Aerosil RY50) are mixed for 2 minutes at a peripheral speed of 33 m/s using a HENSCHEL MIXER. Next, the resultant is sieved with a vibration sieve with a mesh of 45 μm to obtain external addition toner (A1) to (A12), and external addition toner (B1) to (B23).

### Preparation of Carrier

Ferrite particles (volume average particle diameter 35 μm): 100 parts
Cross-linked melamine resin particles (volume average particle diameter 0.3 μm, toluene insoluble): 0.3 parts
Methyl methacrylate-perfluorooctyl ethyl acrylate copolymer: 1.6 parts
Carbon black (VXC-72 manufactured by Cabot Corporation): 0.12 parts
Toluene: 14 parts

Carbon black is diluted in toluene and added to the methyl methacrylate-perfluorooctyl ethyl acrylate copolymer and dispersed in a sand mill. Next, cross-linked melamine resin particles are added thereto, dispersed with a stirrer for 10 minutes, and a dispersion is obtained. Next, the dispersion and the ferrite particles are put into a vacuum degassing kneader and stirred for 30 minutes at a temperature of 60° C., and then the toluene is distilled off under reduced pressure and a resin-coated carrier is obtained.

### Preparation of Developer

36 parts of any of the external addition toners (A1) to (A12) and external addition toners (B1) to (B23) and 414 parts of a resin-coated type carrier are put into a 2 liter V blender, stirred for 20 minutes, and then a developer is obtained by sieving the resultant with a sieve with a mesh of 212 μm. Examples 1 to 24, Comparative Examples 1 to 11: Image Forming

A Color800 Press modified machine manufactured by Fuji Xerox is prepared. The fixing device of the image forming apparatus is provided with the fixing device shown in FIG. 3. Each of the developers shown in Table 1 for the Examples and Comparative Examples is filled into a developer in this image forming apparatus and 10,000 strip-shaped solid images (the toner deposition amount on the image portion is 4.5 g/m²) are output onto paper (OK TOP COAT manufactured by Oji Paper, basis weight of 127 g/m²).

### Evaluation

Element analysis in depth direction of image: depth direction analysis using X-ray photoelectron spectroscopy

Element analysis in the depth direction of the image is performed with the following apparatus and conditions. The results are shown in Table 1.
X-ray photoelectron spectrometer:

Scanning type X-ray photoelectron spectrometer PHI5000 VERSA PROBE II manufactured by ULVAC-PHI INCORPORATED.
Ion gun: Argon GCIB ion gun
Acceleration voltage: 5 kV
Emission current: 10 Ma
Sputtering region: 2 mm×2 mm
Sputtering rate: 20 nm/min (polyester equivalent)

### Brilliance of Image

Under illumination (natural daylight lighting) for color observation in accordance with “Coating-General Test Method-Part 4: Coating Film Visual Characteristics, section 3: Visual Color Comparison” in JIS K5600-4-3: 1999, the sparkle (glittering effect) and the optical effect (hue change due to the viewing angle) are observed visually, and the 5,000th sheet and the 10,000th sheet are each compared with the first sheet and classified as follows. The results are shown in Table 1. G2 or greater is acceptable.

G7: The 5,000^{th} and 10,000^{th} sheets have a sparkle and an optical effect, and there is no problem.
G6: Although there is no problem with the 5,000^{th} sheet, the sparkle and the optical effect of the 10,000^{th} sheet are slightly deteriorated.
G5: The sparkle and the optical effect of the 5,000^{th} sheet and the 10,000^{th} sheet are slightly deteriorated.
G4: The sparkle and the optical effect of the 10,000^{th} sheet are deteriorated within an acceptable range.
G3: The sparkle and the optical effect of the 5,000^{th} and 10,000^{th} sheets are deteriorated within an acceptable range.
G2: The 5,000^{th} sheet is in the acceptable range; however, the sparkle and the optical effect are deteriorated in the 1,000^{th} sheet.
G1: There is no sparkle or optical effect in the 5,000^{th} sheet, and there is a problem.

TABLE 1

| | Brilliant | | | | | | | |
|---|---|---|---|---|---|---|---|---|
| | toner | | | | Brilliant image | | | |
| | particles | Brilliant image | | | Depth | | | |
| | forming | Depth 200 nm | | | 1,000 nm | | | Brilliance |
| | developer | A | B | C | A | B | C | of image |
| Example 1 | A2 | 9.6 | 12 | 23 | 38 | 21 | 22 | G4 |
| Example 2 | A3 | 5.5 | 17 | 36 | 33 | 28 | 36 | G4 |
| Example 3 | A4 | 4.6 | 23 | 40 | 29 | 32 | 38 | G7 |
| Example 4 | A5 | 3.0 | 27 | 45 | 26 | 34 | 41 | G6 |
| Example 5 | A6 | 3.0 | 30 | 47 | 24 | 36 | 43 | G6 |
| Example 6 | A7 | 1.4 | 33 | 55 | 21 | 38 | 47 | G6 |
| Example 7 | A8 | 1.3 | 35 | 55 | 18 | 40 | 47 | G5 |
| Example 8 | A9 | 0.7 | 38 | 59 | 15 | 47 | 48 | G5 |
| Example 9 | A10 | 0.6 | 42 | 63 | 14 | 52 | 48 | G2 |
| Example 10 | A11 | 0.2 | 48 | 69 | 12 | 58 | 48 | G2 |
| Comparative | A1 | 12 | 9 | 18 | 43 | 18 | 18 | G1 |
| Example 1 | | | | | | | | |
| Comparative | A12 | 0.1 | 53 | 74 | 8 | 63 | 53 | G1 |
| Example 2 | | | | | | | | |
| Example 11 | B1 | 3.2 | 37 | 52 | 24 | 30 | 36 | G7 |
| Example 12 | B4 | 2.3 | 25 | 63 | 17 | 22 | 49 | G3 |
| Example 13 | B5 | 2.5 | 28 | 59 | 19 | 24 | 45 | G4 |
| Example 14 | B6 | 2.8 | 32 | 55 | 21 | 27 | 40 | G5 |
| Example 15 | B7 | 3.7 | 45 | 48 | 28 | 35 | 32 | G5 |
| Example 16 | B12 | 2.3 | 33 | 41 | 18 | 27 | 22 | G5 |
| Example 17 | B13 | 2.6 | 34 | 45 | 19 | 28 | 26 | G5 |
| Example 18 | B14 | 2.9 | 36 | 48 | 22 | 29 | 31 | G6 |
| Example 19 | B15 | 3.5 | 39 | 56 | 26 | 32 | 42 | G6 |
| Example 20 | B16 | 3.9 | 41 | 59 | 29 | 33 | 49 | G5 |
| Example 21 | B19 | 3.4 | 23 | 56 | 26 | 21 | 39 | G6 |
| Example 22 | B20 | 3.3 | 31 | 54 | 25 | 26 | 38 | G6 |
| Example 23 | B21 | 3.0 | 44 | 49 | 23 | 34 | 35 | G6 |
| Example 24 | B22 | 2.9 | 49 | 48 | 22 | 37 | 34 | G6 |
| Comparative | B2 | 2.0 | 21 | 69 | 15 | 19 | 61 | G1 |
| Example 3 | | | | | | | | |
| Comparative | B3 | 2.1 | 23 | 66 | 16 | 20 | 55 | G1 |
| Example 4 | | | | | | | | |
| Comparative | B8 | 4.5 | 55 | 43 | 34 | 40 | 28 | G1 |
| Example 5 | | | | | | | | |
| Comparative | B9 | 5.8 | 73 | 36 | 43 | 46 | 23 | G1 |
| Example 6 | | | | | | | | |
| Comparative | B10 | 1.9 | 30 | 34 | 14 | 26 | 15 | G1 |
| Example 7 | | | | | | | | |
| Comparative | B11 | 2.1 | 31 | 38 | 16 | 26 | 18 | G1 |
| Example 8 | | | | | | | | |
| Comparative | B17 | 4.3 | 44 | 63 | 32 | 34 | 56 | G1 |
| Example 9 | | | | | | | | |
| Comparative | B18 | 3.6 | 15 | 59 | 27 | 14 | 41 | G1 |
| Example 10 | | | | | | | | |
| Comparative | B23 | 2.8 | 55 | 46 | 21 | 40 | 32 | G1 |
| Example 11 | | | | | | | | |

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming method comprising:
charging a surface of an image holding member;
forming an electrostatic charge image on a charged surface of the image holding member;
developing the electrostatic charge image formed on the surface of the image holding member as a developed image by using an electrostatic charge image developer including toner particles which contain a binder resin, a flake shape brilliant pigment, and a layered inorganic material;
transferring the toner image formed on the surface of the image holding member onto a surface of a recording medium; and
fixing the toner image, which is a brilliant image, on the surface of the recording medium by passing the recording medium onto which the toner image is transferred through a contact region between a fixing member and a pressing member is pressed to the fixing member,
wherein the brilliant image satisfies conditions (1) and (2) below:
(1) at a depth of 200 nm of the brilliant image, A<10, 10≦B≦50, and 20≦C≦70 and
(2) at a depth of 1,000 nm of the brilliant image, 10≦A≦40, 20≦B≦60, and 20≦C≦50,
wherein A, B and C are element amounts (atomic %) analyzed by X-ray photoelectron spectroscopy, A is an aluminium element amount, B is a silicon element amount, and C is a carbon element amount.

2. The image forming method according to claim 1,
wherein the toner particles include a flake shape aluminum pigment as the flake shape brilliant pigment.

3. The image forming method according to claim 1,
wherein a ratio of an average length in a long-axis direction and an average length in a thickness direction of the brilliant pigment (average length in a long-axis direction/average length in a thickness direction) is from 5 to 200.

4. The image forming method according to claim 1,
wherein a content of the brilliant pigment is 1% by weight to 50% by weight with respect to a total amount of the toner particles.

5. The image forming method according to claim 1,
wherein the layered inorganic material includes montmorillonite.

6. The image forming method according to claim 1,
wherein a content of the layered inorganic material is 0.005% by weight to 2% by weight with respect to a total amount of the toner particles.

7. The image forming method according to claim 1,
wherein a toner particle surface layer uneven distribution index of the layered inorganic material is 80 or more.

8. The image forming method according to claim 1,
wherein 80% or more of all of the layered inorganic material is present in a range of a depth of 5 nm to 20 nm from a surface of the toner particles.

9. The image forming method according to claim 1,
wherein the toner particles contain a polyester resin having a cross-linked structure as the binder resin.

10. The image forming method according to claim 9,
wherein the polyester resin is a urea-modified polyester resin.

11. The image forming method according to claim 10,
wherein a content of the urea-modified polyester resin is 5% by weight to 40% by weight with respect to a total amount of the binder resin.

12. The image forming method according to claim 10,
wherein a glass transition temperature of the urea-modified polyester resin is from 40° C. to 65° C.

13. The image forming method according to claim 10,
wherein a weight average molecular weight of the urea-modified polyester resin is from 10,000 to 500,000.

14. The image forming method according to claim 1,
wherein the toner particles contain a release agent having a melting temperature of 50° C. to 110° C.

15. An image forming apparatus comprising:
a charging unit which charges a surface of an image holding member;
an electrostatic charge image forming unit which forms an electrostatic charge image on a charged surface of the charged image holding member;
a developing unit which stores an electrostatic charge image developer including toner particles which contain a binder resin, a flake shape brilliant pigment, and a layered inorganic material and which develops the electrostatic charge image formed on the surface of the image holding member as a developer image by using the electrostatic charge image developer;
a transfer unit which transfers the toner image formed on the surface of the image holding member onto a surface of a recording medium; and
a fixing unit which has a fixing member and a pressing member is pressed to the fixing member, and passes the recording medium onto which the toner image is transferred through a contact region between the fixing member and the pressing member to thereby fix the toner image, which is a brilliant image, on the surface of the recording medium,
wherein the brilliant image satisfies conditions (1) and (2) below:
(1) at a depth of 200 nm of the brilliant image, A<10, 10≦B≦50, and 20≦C≦70 and
(2) at a depth of 1,000 nm of the brilliant image, 10≦A≦40, 20≦B≦60, and 20≦C≦50,
wherein A, B and C are element amounts (atomic %) analyzed by X-ray photoelectron spectroscopy, A is an aluminum element amount, B is a silicon element amount, and C is a carbon element amount.

16. The image forming apparatus according to claim 15,
wherein the toner particles include a flake shape aluminum pigment as the flake shape brilliant pigment.

17. The image forming apparatus according to claim 15,
wherein the toner particles contain montmorillonite as the layered inorganic material.

18. The image forming apparatus according to claim 15,
wherein a content of the layered inorganic material is 0.005% by weight to 2% by weight with respect to the toner particles.

19. The image forming apparatus according to claim 15,
wherein the toner particles include a polyester resin having a cross-linked structure as the binder resin.
